(19) United States
(12) Patent Application Publication
(10) Pub. No.: US 2026/0246282 A1
(43) Pub. Date: Aug. 20, 2026

(54) METHODS OF ROBUST UNIT SCHEDULING FOR TRANSMISSION AND DISTRIBUTION NETWORKS BASED ON FULL FREQUENCY RESPONSE PROCESSES

(71) Applicant: NORTHEAST ELECTRIC POWER UNIVERSITY, Jilin City (CN)

(72) Inventors: Rufeng ZHANG, Jilin City (CN); Kefei YAN, Jilin City (CN); Yanjing CHEN, Jilin City (CN); Guoqing LI, Jilin City (CN); Houhe CHEN, Jilin City (CN); Tao JIANG, Jilin City (CN); Xue LI, Jilin City (CN)

(73) Assignee: NORTHEAST ELECTRIC POWER UNIVERSITY, Jilin City (CN)

(21) Appl. No.: 19/534,710

(22) Filed: Feb. 9, 2026

(30) Foreign Application Priority Data
Feb. 17, 2025 (CN) 202510171301.9

(51) Int. Cl. H02J 3/466; H02J 3/00; H02J 3/38; H02J 101/24; H02J 101/28; H02J 103/30

(52) U.S. Cl. CPC H02J 3/466; H02J 3/003; H02J 3/004; H02J 3/381; H02J 2101/24; H02J 2101/28; H02J 2103/30

(57) ABSTRACT

Disclosed is a method of robust unit scheduling for a transmission and distribution network based on a full frequency response process. The method includes: constructing full-process frequency security constraints for three stages of inertia response, primary frequency regulation, and secondary frequency regulation; establishing a two-stage robust unit commitment optimization model for the transmission and distribution network with a min-max-min structure that considers the full frequency response process, with objectives of minimizing start-stop costs, generation costs, and primary and secondary frequency regulation reserve costs; and transforming the two-stage robust unit commitment optimization model for the transmission and distribution network into a mixed-integer second-order cone programming model by using a column-and-constraint generation algorithm and a strong duality theory, followed by iterative solution.

### CROSS-REFERENCE TO RELATED APPLICATIONS

This application claims priority to Chinese Patent Application No. 202510171301.9, filed on Feb. 17, 2025, the entire contents of which are hereby incorporated by reference.

### TECHNICAL FIELD

The present disclosure relates to a technical field of electric power systems, and in particular to a method of robust unit scheduling for a transmission and distribution network based on a full frequency response process.

### BACKGROUND

With the rapid development of distributed generation technologies such as renewable energy generation, an increasing number of Distributed Energy Resources (DERs) are participating in traditional distribution networks. This has promoted the gradual transformation of traditional distribution networks into Active Distribution Networks (ADNs), making the characteristics of multi-energy complementarity and bidirectional energy flow increasingly evident. However, current independent optimization methods for transmission and distribution networks can easily lead to power imbalances on boundary lines and generate unnecessary grid congestion. Furthermore, they may result in insufficient utilization of grid resources, failing to guarantee the overall optimality of scheduling results. Therefore, how to harness ADN resources and achieve coordinated scheduling with the transmission network has become a critical problem urgently needing resolution.

In recent years, renewable energy units, primarily wind and solar, have been integrated into the network on a large scale, with installed capacity increasing annually. Wind turbines and photovoltaic units are typically connected to the grid via power electronic devices. Compared to conventional units, the renewable energy units offer advantages such as flexible control manners and rapid response speeds. However, since the active power output of these renewable energy units is nearly decoupled from grid frequency, they lack frequency response capability. This weak regulation characteristic poses a significant challenge to the frequency security of the network. If frequency deviations persist in the grid over the long term, the safety and reliability of the power system may be severely affected.

Additionally, the output of renewable energy units such as wind and photovoltaic power is highly uncertain due to various factors including weather, time, and geographical location. As an important aspect of system operation and control, Unit Commitment (UC) determines start-stop states of units on a day-ahead basis, directly affecting the system's dispatchable frequency regulation resource reserves for the following day. Therefore, embedding frequency security constraints into a Unit Commitment model (Frequency Constrained Unit Commitment, FCUC) has become a crucial measure for maintaining system frequency security.

Current optimization approaches for handling uncertainties primarily fall into two categories: stochastic optimization and robust optimization. Stochastic optimization describes the uncertainty of wind and photovoltaic power output using random variables under certain probabilities. However, the stochastic optimization approach has drawbacks in practical applications, such as large computational loads, long computation times, and difficulty in determining prior probability distributions. The robust optimization approach assumes that uncertain data in the model belongs to a given uncertainty set and seeks a robust solution that is feasible for any uncertain data within that set. It offers advantages such as not requiring precise probability distribution information for uncertain parameters and faster computation.

Therefore, it is desirable to provide a method of robust unit scheduling for a transmission and distribution network based on a full frequency response process. The method can avoid overly conservative results that lead to poor practical performance of the robust optimization approach. It achieves this by determining a portion of decision variables before uncertain parameters are known, and determining another portion of the decision variables after the uncertain parameters are known, thereby gradually adjusting decisions and improving the conservativeness of the system.

### SUMMARY

One or more embodiments of the present disclosure provide a method of robust unit scheduling for a transmission and distribution network based on a full frequency response process. The method comprises: establishing a framework structure of the transmission and distribution network, taking into account start-stop states of thermal power units, and analyzing a dynamic frequency response process in which centralized renewable energy units and distributed energy resources jointly provide frequency support together with the thermal power units, wherein full-process frequency security constraints are constructed for three stages including inertia response, primary frequency regulation, and secondary frequency regulation. The full-process frequency security constraints include primary frequency regulation security constraints and secondary frequency regulation security constraints. The primary frequency regulation security constraints include:

A Rate of Change of Frequency (RoCoF) constraint, wherein when a power deficit begins to occur in a transmission and distribution network system, a system frequency deviation Δfₜ≈0, at which time no units in the transmission and distribution network system have taken action, and a system rate of change of frequency is required to satisfy a maximum allowable requirement, wherein a system inertia time constant is jointly determined by inertia time constants of all dispatchable frequency regulation resources within the transmission and distribution network system, and the RoCoF constraint is expressed as:

$$RoCoF = \frac{\partial Δ {f}_{t}}{\partial t} = \frac{\vert Δ {P}_{L , t} \vert \cdot {f}_{0}}{2 {H}_{g , t}} \leq {RoCoF}^{max}$$

wherein RoCoF denotes the system rate of change of frequency; Δfₜ denotes a system frequency deviation after an occurrence of the power deficit at a time t; f₀ denotes a system nominal frequency; ΔP_{L,t} denotes a system power deficit; H_{g,t} denotes a system inertia time constant at the time t; RoCoF^{max} denotes the maximum allowable requirement of the system rate of change of frequency.

A frequency nadir constraint, wherein the inertia response and the primary frequency regulation jointly act to cause a system frequency to decrease to a frequency nadir, during which each unit is required to reserve a primary frequency regulation reserve capacity to participate in the primary frequency regulation so as to prevent the system frequency deviation after the occurrence of the power deficit at the time t from exceeding a given safety threshold, and the system frequency is expressed as:

$$\vert Δ {f}_{nadir , t} \vert = \frac{2 {R}_{t}^{P} {H}_{g , t}}{{{T}_{d}^{P} ( {DP}_{t}^{D} )}^{2}} log ( \frac{2 {R}_{t}^{P} {H}_{g , t}}{{T}_{d}^{P} {DP}_{t}^{D} Δ {P}_{L , t}^{′} + 2 {R}_{t}^{P} {H}_{g , t}} ) + \frac{Δ {P}_{L , t}^{′}}{{DP}_{t}^{D}} + Δ {f}_{DB} \leq Δ {f}^{max}$$

wherein |Δf_{nadir,t}| denotes the system frequency deviation at the time t;

$${R}_{t}^{P}$$

denotes a sum of primary frequency regulation reserve capacities of units in the transmission and distribution network system at the time t;

$${T}_{d}^{P}$$

denotes a response time of the primary frequency regulation of the transmission and distribution network system; D denotes a load damping coefficient;

$${P}_{t}^{D}$$

denotes a system load;

$$Δ {P}_{L , t}^{′}$$

denotes power deficit of the transmission and distribution network system when entering the inertia response at the time t; Δf_{DB} denotes a frequency dead band; Δf^{max} denotes the given safety threshold.

A quasi-steady-state frequency constraint, wherein when the primary frequency regulation reserve capacities of the units in the transmission and distribution network system are fully released, the system frequency is maintained at a quasi-steady-state frequency, and a quasi-steady-state frequency deviation at the time t is required to be controlled within a maximum allowable range

$$Δ {f}_{qss}^{max}$$

of the transmission and distribution network system, and the quasi-steady-state frequency constraint is expressed as:

$$\vert Δ {f}_{qss , t} \vert = \frac{Δ {P}_{L , t} - {R}_{t}^{P}}{{DP}_{t}^{D}} \leq Δ {f}_{qss}^{max} ;$$

wherein |Δf_{qss,t}| denotes the quasi-steady-state frequency deviation at the time t.

The secondary frequency regulation security constraints include:

A secondary frequency regulation reserve capacity constraint, wherein, in order to restore the system frequency to a nominal frequency value by an end of the secondary frequency regulation, a sum of secondary frequency regulation reserve capacities and the primary frequency regulation reserve capacities of the units in the transmission and distribution network system is not less than the system power deficit, and the secondary frequency regulation reserve capacity constraint is expressed as:

$${R}_{t}^{P} + {R}_{t}^{S} \geq Δ {P}_{L , t} ;$$

wherein

$${R}_{t}^{S}$$

denotes a sum of the secondary frequency regulation reserve capacities of the units in the transmission and distribution network system at the time t;

A secondary frequency regulation frequency deviation accumulation constraint, wherein an accumulated amount of secondary frequency regulation frequency deviation in the transmission and distribution network system is required to be maintained within a predetermined range so as to avoid excessive deviation of the system frequency from the nominal frequency value at a beginning of the secondary frequency regulation, and the secondary frequency regulation frequency deviation accumulation constraint is expressed as:

$${SFR}^{min} \leq ( Δ {P}_{L , t} - {R}_{t}^{P} - {R}_{t}^{S} ) \frac{{t}^{s} - 2 {σ}_{2}}{20 {σ}_{1}} \leq {SFR}^{max}$$

wherein t^{s} denotes an ending time of the accumulated secondary frequency regulation frequency deviation in the transmission and distribution network system; σ₁ denotes a system frequency deviation coefficient; σ₂ denotes an integral control parameter; SFR^{max} and SFR^{min} denote an upper limit and a lower limit of the accumulated secondary frequency regulation frequency deviation in the transmission and distribution network system, respectively;

The method further includes: constructing an uncertainty set of wind power output and an uncertainty set of photovoltaic power output in an interval form by considering uncertainty of wind power output and uncertainty of photovoltaic power output, establishing a two-stage robust unit commitment optimization model of the transmission and distribution network considering the full-process frequency response with a min-max-min structure, and minimizing a sum of start-stop costs, generation costs, primary frequency regulation reserve costs, and secondary frequency regulation reserve costs as an objective.

The method further includes: converting, by using a column-and-constraint generation algorithm and a strong duality theory, the two-stage robust unit commitment optimization model of the transmission and distribution network into a mixed-integer second-order cone programming model, and iteratively solving the mixed-integer second-order cone programming model until an upper bound and a lower bound of an objective function converge, thereby obtaining an optimal unit scheduling scheme under a worst-case scenario of the wind power output and the photovoltaic power output.

Compared with the existing technologies, the beneficial effects of the present disclosure include but are not limited to the following:

Some embodiments of the present disclosure embed full-process frequency security constraints into unit commitment. This allows for flexible adjustment of the generation power and frequency regulation power of thermal power units. After considering the frequency support capability of the active distribution network for the transmission network, the start-stop states and start-stop costs costs of thermal power units can be reduced, effectively alleviating the operational pressure on thermal power units, promoting coordinated operation between the transmission network and the distribution network, and improving the economic efficiency of system operation.

Some embodiments of the present disclosure consider the full-process frequency security constraints, ensuring that frequency security indicators remain within safe thresholds after primary frequency regulation and that the system frequency is restored to the nominal frequency value of 50 Hz through secondary frequency regulation, thereby safeguarding system frequency security. After considering the participation of distributed energy resources in frequency regulation, both the total system operating cost and the frequency regulation reserve cost are reduced, achieving optimal and economical operation of the transmission network and the distribution network.

Some embodiments of the present disclosure, based on the output uncertainty of the wind power units on the transmission network side and distributed photovoltaic units on the active distribution network side, flexibly adjust the conservativeness of the system by varying the uncertainty levels of wind and photovoltaic power. This enables the scheduling scheme developed under the worst-case scenarios of wind power output and photovoltaic power output to possess greater robustness and stability. The method is conducive to improving the system's frequency regulation capability under fluctuations in wind and photovoltaic power output, thereby achieving optimal operation of the transmission network and the distribution network.

### BRIEF DESCRIPTION OF THE DRAWINGS

The present disclosure will be further elucidated by way of exemplary embodiments, which are described in detail with reference to the accompanying drawings. These embodiments are not limiting. In these embodiments, the same reference numerals denote the same structures, wherein:

FIG. 1 is a flowchart illustrating an exemplary process of a method for robust unit scheduling of a transmission and distribution network based on a full frequency response process according to some embodiments of the present disclosure;

FIG. 2 is a schematic diagram illustrating a method for robust unit scheduling of a transmission and distribution network based on a full frequency response process according to some embodiments of the present disclosure;

FIG. 3 is a schematic diagram illustrating a framework structure of a transmission and distribution network according to some embodiments of the present disclosure;

FIG. 4 is a schematic diagram illustrating a test case system according to some embodiments of the present disclosure;

FIG. 5 is a schematic diagram illustrating system load forecasting according to some embodiments of the present disclosure;

FIG. 6 is a comparison chart illustrating frequency nadirs for Scenario 1, Scenario 2, and Scenario 3 according to some embodiments of the present disclosure;

FIG. 7 is a comparison chart illustrating system Rates of Change of Frequency (RoCoF) for Scenario 1, Scenario 2, and Scenario 3 according to some embodiments of the present disclosure; and

FIG. 8 is a comparison chart illustrating quasi-steady-state frequencies for Scenario 2 and Scenario 3 according to some embodiments of the present disclosure.

### DETAILED DESCRIPTION

To more clearly illustrate the technical solutions in the embodiments of the present disclosure, the drawings used in the description of the embodiments will be briefly introduced below. Obviously, the drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

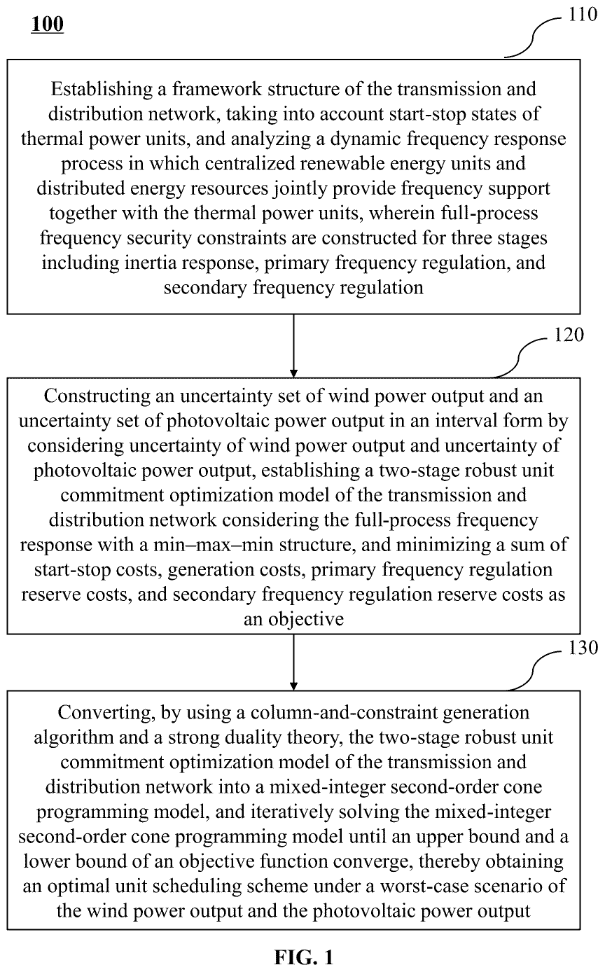

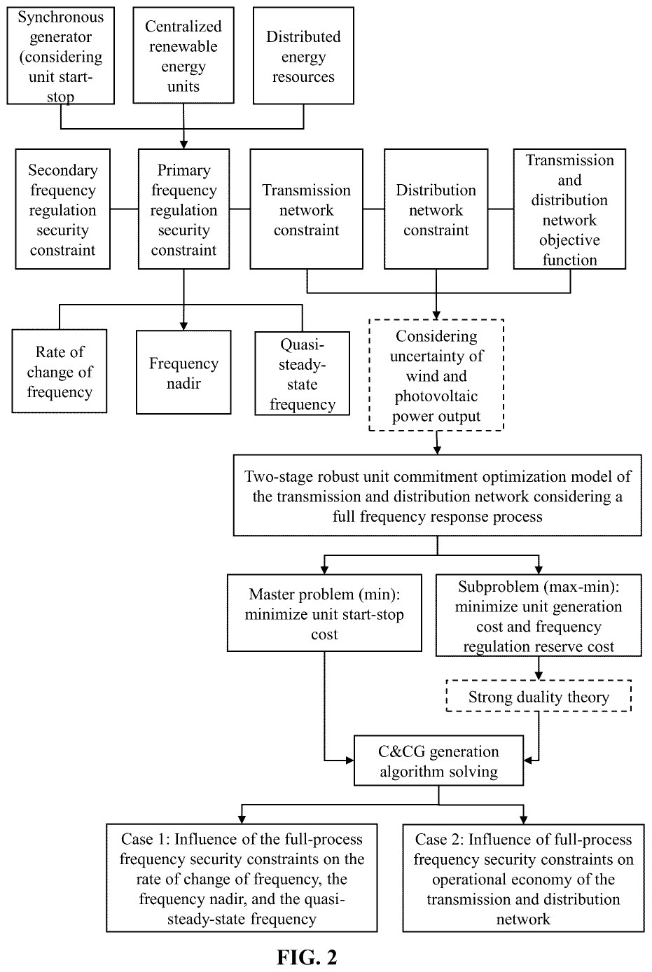

FIG. 1 is a flowchart illustrating an exemplary process of a method for robust unit scheduling of a transmission and distribution network based on a full frequency response process according to some embodiments of the present disclosure. FIG. 2 is a schematic diagram illustrating a method for robust unit scheduling of a transmission and distribution network based on a full frequency response process according to some embodiments of the present disclosure.

In some embodiments, as shown in FIG. 1, a process 100 may be executed by a processor, and the process 100 may include steps 110 to 130.

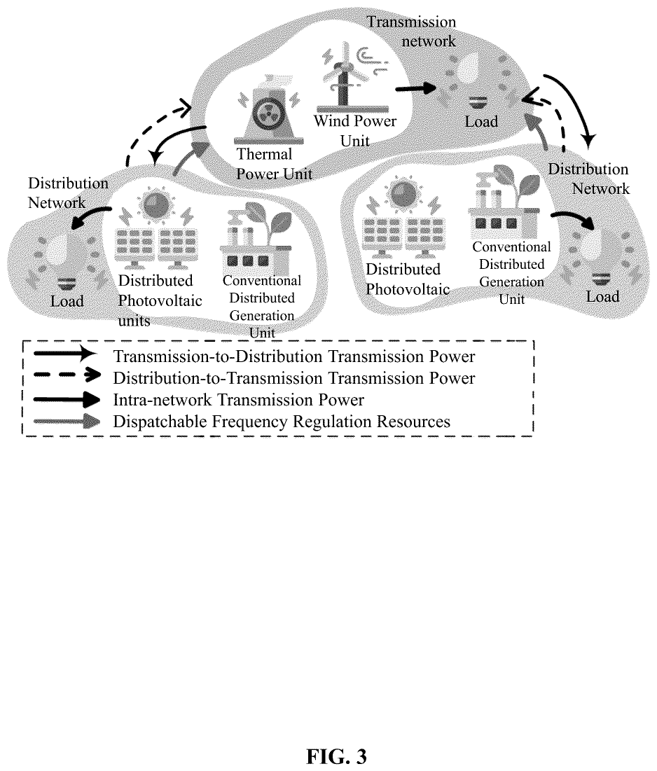

In some embodiments, the processor may include one or more sub-processing devices (e.g., a single-core processing device or a multi-core multi-chip processing device). Merely by way of example, the processor may include a Central Processing Unit (CPU), an Application-Specific Integrated Circuit (ASIC), an Application-Specific Instruction Processor (ASIP), a Graphics Processing Unit (GPU), a Physics Processing Unit (PPU), a Digital Signal Processor (DSP), a Field-Programmable Gate Array (FPGA), a Programmable Logic Device (PLD), a controller, a Microcontroller Unit (MCU), a Reduced Instruction Set Computer (RISC), a microprocessor, or any combination thereof. In some embodiments, the processor may be local or remote, and the processor may be integrated into a transmission and distribution network system as shown in FIG. 3.

In 110, establishing a framework structure of the transmission and distribution network, taking into account start-stop states of thermal power units, and analyzing a dynamic frequency response process in which centralized renewable energy units and distributed energy resources jointly provide frequency support together with the thermal power units, wherein full-process frequency security constraints are constructed for three stages including inertia response, primary frequency regulation, and secondary frequency regulation.

The transmission and distribution network refers to an interconnected power network formed by coupling transmission systems and distribution systems through tie lines.

In some embodiments, the transmission and distribution network is capable of achieving long-distance transmission, regional distribution, and local consumption of electrical energy.

The framework structure of the transmission and distribution network refers to a general network structure for constructing the transmission and distribution network (e.g., connection manners of nodes, lines, generator units, substations, etc.). The manner for constructing the framework structure of the transmission and distribution network is a standard practice in power system design and will not be elaborated here.

FIG. 3 is a schematic diagram illustrating a framework structure of a transmission and distribution network according to some embodiments of the present disclosure.

In some embodiments, as shown in FIG. 3, within the framework structure of the transmission and distribution network, dispatchable frequency regulation resources of a transmission network include thermal power units and wind power units considering start-stop. Dispatchable frequency regulation resources of an active distribution network include conventional distributed generator units and photovoltaic units. Power between the transmission network and the distribution network is balanced through bidirectional transmission so as to balance an overall load of the transmission and distribution network system and satisfy a frequency security requirement of the transmission and distribution network system. The transmission and distribution network is also referred to as the transmission and distribution network system.

Dispatchable frequency regulation resources refer to controllable resources that may be used to adjust their output to support system frequency. For example, dispatchable frequency regulation resources may be thermal power units, wind power units, distributed generator units, photovoltaic units, etc.

The dispatchable frequency regulation resources of the transmission network refer to the dispatchable frequency regulation resources located on the transmission network side.

The dispatchable frequency regulation resources of the active distribution network refer to the dispatchable frequency regulation resources located on the distribution network side.

Output may also be referred to as power.

A thermal power unit refers to a traditional generator unit that uses fossil fuels as its energy source and is connected to the grid through a synchronous generator. The fossil fuels may include coal, natural gas, etc.

A wind power unit refers to a renewable energy generator unit that uses wind energy as its energy source and is connected to the grid through power electronic converters.

The start-stop state of a generator unit refers to state information describing whether the generator unit (e.g., a thermal power unit, a wind power unit) is operating or shut down. For example, the start-stop state may include an operating state (also referred to as a start-up state) and a shutdown state (also referred to as a stop state).

In some embodiments, the processor may treat the start-stop states of thermal power units as variables, determine start-stop costs of the thermal power units, and activate corresponding constraints (e.g., only when a unit is in the operating state do constraints on its active power output and frequency regulation reserve capacity become effective, and a minimum continuous operating time must be satisfied; when in the shutdown state, the output of thermal power unit is forced to zero, and a minimum continuous shutdown time must be satisfied). Active power output refers to the actual electrical power delivered to the grid by a generator unit during steady-state operation.

The dispatchable frequency regulation resources of the active distribution network refer to the dispatchable frequency regulation resources located on the distribution network side.

Conventional distributed generator units refer to generator units connected to the distribution network, characterized by relatively small capacity and fixed fuel sources. For example, conventional distributed generator units may include natural gas generator units, diesel generator units, etc.

A photovoltaic unit refers to a photovoltaic power generator unit configured on the distribution network side.

The overall load of the transmission and distribution network system refers to a total active power demand of the transmission and distribution network system.

In some embodiments, based on historical load data and meteorological information, the processor may determine a predicted load value for each node in the transmission and distribution network using a load forecasting model, and sum these predicted load values of the nodes in the transmission and distribution network to obtain the overall load. The historical load data refers to data reflecting a load condition of the transmission and distribution network system from past periods. The load forecasting model may be a trained machine learning model.

The frequency security requirement of the transmission and distribution network system (also referred to as a system frequency security requirement) refers to a requirement for the safe and stable operation of a system frequency. For example, the system frequency security requirement may stipulate that the system frequency (also referred to as the frequency) must remain within a range defined by a safety threshold. The safety threshold refers to an allowable deviation range that ensures the frequency stability of the power system. In some embodiments, the safety threshold may be preset by technical personnel based on experience.

In some embodiments of the present disclosure, a bilateral coordinated frequency regulation framework for the transmission and distribution network is constructed. This framework clarifies that thermal power units and wind power units on the transmission network side, and distributed energy resources and photovoltaic units on the distribution network side, engage in bidirectional power interaction via tie lines. This approach can fully exploit the frequency regulation potential of the distribution network, enhance the overall system frequency regulation capability, effectively alleviate the frequency regulation pressure on thermal power units, promote the local consumption and deep participation of renewable energy sources, and improve the flexibility and economic efficiency of the scheduling scheme.

The centralized renewable energy units refer to renewable energy generator units deployed on a large scale and in a concentrated manner. For example, centralized renewable energy units may include wind power units, etc.

The distributed energy resources refer to small-scale distributed power generation systems located in various regions. For example, the distributed energy resources may include small wind turbines, small photovoltaic units, etc.

The frequency support refers to a coordinated regulation capability that, when a power deficit occurs in the system, keeps a system frequency deviation (also referred to as frequency deviation) within the safety threshold and restores it to a rated value.

The power deficit refers to the shortfall between a total generated power and a total load demand in the transmission and distribution network system.

In some embodiments, the processor may determine a difference between the total load demand and the total generated power as the power deficit.

In some embodiments, based on historical load data, the processor may determine the total load demand, and based on the generated power of each unit, determine the total generated power. The historical load data refers to the electricity consumption required during historical power supply periods.

The system frequency deviation refers to a difference between an actual frequency of the transmission and distribution network system and a rated frequency.

In some embodiments, the processor may acquire the system frequency in real-time through a frequency monitoring device, and the rated frequency may be preset by the processor based on default settings. The frequency monitoring device may include a phasor measurement unit, a digital frequency relay, an electric meter, etc.

The safety threshold refers to a maximum allowable range of system frequency deviation for the safe and stable operation of the transmission and distribution network system.

In some embodiments, the safety threshold may be preset by technical personnel based on experience.

The dynamic frequency response process refers to a full dynamic regulation process involved in providing the frequency support.

In some embodiments, when a power deficit occurs in the transmission and distribution network system, the centralized renewable energy units, the distributed energy resources, and the thermal power units jointly provide the frequency support by releasing a frequency regulation reserve capacity, dynamically progressing through three stages of inertia response, primary frequency regulation, and secondary frequency regulation. The frequency regulation reserve capacity refers to a power capacity reserved by generator units to meet frequency regulation needs, which is not used for steady-state power generation but can be rapidly released within a specific period. In some embodiments, the frequency regulation reserve capacity may include a primary frequency regulation reserve capacity and a secondary frequency regulation reserve capacity.

For more details on the primary frequency regulation reserve capacity and the secondary frequency regulation reserve capacity, please refer to the relevant descriptions below.

In some embodiments, after a power deficit occurs in the transmission and distribution network system, the system frequency shows a declining trend, and the system enters the dynamic frequency response process. The dynamic frequency response process includes: inertia response, wherein kinetic energy is provided by inertia within the transmission and distribution network system to regulate the system frequency, generator units do not operate, and the system rate of change of frequency (RoCoF) of the transmission and distribution network system reaches a maximum value; primary frequency regulation, wherein the generator units in the transmission and distribution network system start to change mechanical power, the inertia response and the primary frequency regulation jointly regulate the power deficit, the thermal power units in the transmission network regulate generation power and frequency regulation power based on predetermined unit start-stop decisions, wind power units in the transmission network and distributed generator units and photovoltaic units in an active distribution network directly allocate the wind power output, the photovoltaic power output, and frequency regulation resources, until unit power output equals a disturbance, and the system frequency drops to a frequency nadir f_{nadir}; and the secondary frequency regulation, wherein, when the frequency stabilizes at the quasi-steady-state frequency f_{qss}, the primary frequency regulation ends, and the transmission and distribution network system continues to perform the secondary frequency regulation until the system frequency is restored to the nominal frequency value.

The inertia response refers to an initial rapid decline process of the system frequency caused by the automatic release of kinetic energy from rotors of all operating generator units after a power deficit occurs and before generator speed governors act.

The primary frequency regulation refers to a frequency regulation process where, after the inertia response ends, generator units utilize the primary frequency regulation reserve capacity to suppress the frequency decline. The primary frequency regulation reserve capacity refers to an emergency reserve capacity used to prevent the system frequency from dropping to its lowest point.

The secondary frequency regulation refers to a frequency regulation process that precisely adjusts the system frequency through automatic generation control, using the secondary frequency regulation reserve capacity to restore the system frequency to the rated value. The secondary frequency regulation reserve capacity refers to a sustained reserve capacity that is gradually released through automatic generation control to accurately restore the system frequency to the rated value.

In some embodiments, the inertia response provides initial power support through the instantaneous release of rotor kinetic energy to slow the rate of frequency decline, buying time for the active release of the primary frequency regulation reserve capacity. The inertia response and the primary frequency regulation overlap in time and complement each other in function within a short period (e.g., 10-30 seconds) after a disturbance, jointly keeping the power deficit within a safe range. For example, when a 100 MW power deficit occurs in the transmission and distribution network system, the inertia response provides approximately 30 MW of instantaneous support within the first 10 seconds, followed by the primary frequency regulation releasing 70 MW of reserve capacity within 20 seconds. Together, they offset the deficit, preventing the frequency from falling below 49.2 Hz.

In some embodiments, wind power units directly allocate output and frequency regulation resources along with conventional distributed generator units and photovoltaic units within the active distribution network.

For example, in a transmission and distribution network composed of an IEEE 24-node transmission system and two IEEE 33-node distribution networks, when a 150 MW power deficit occurs at time t=15 due to a sudden load increase and deviations in wind/photovoltaic power forecasts, the processor first identifies a worst-case scenario through a sub-problem where a wind power output and a photovoltaic power output are at lower bounds of their intervals (wind power at 140 MW, photovoltaic power at 15 MW), thereby expanding an equivalent deficit to 225 MW. Subsequently, frequency regulation resources are directly allocated: Thermal unit G1 utilizes virtual inertia and physical inertia support to limit the rate of change of frequency (RoCoF) to 0.11 Hz/s, releases 80 MW of primary frequency regulation reserve, and reserves 45 MW of secondary frequency regulation reserve. Wind unit W1 releases 40 MW of primary frequency regulation reserve via pitch angle control and reserves 20 MW of secondary frequency regulation reserve. Distributed gas turbine DG1 within the distribution network rapidly increases its load to provide 30 MW of primary frequency regulation reserve and reserves 15 MW of secondary frequency regulation reserve. Photovoltaic unit PV1 provides 15 MW of primary frequency regulation reserve and 15 MW of secondary frequency regulation reserve through inverter power curtailment. Through the coordinated action of these resources, the system frequency reaches a nadir of 49.3 Hz and a quasi-steady-state frequency of 49.7 Hz, recovering to 50 Hz after the secondary frequency regulation. The total frequency regulation cost is 42,000 CNY, representing a 38% reduction compared to relying solely on thermal power units for frequency regulation.

Inertia refers to a physical quantity describing an ability of the transmission and distribution network system to resist frequency changes. In some embodiments, inertia may also be referred to as a system inertia time constant.

Kinetic energy regulating frequency refers to the electromagnetic power automatically converted from the kinetic energy stored in the rotating components (rotors) of generator units when a power deficit occurs in the system.

In some embodiments, the processor may determine the kinetic energy stored in the rotating components (rotors) of generator units based on the inertia within the transmission and distribution network system, and convert the automatic release of the kinetic energy into kinetic energy regulating frequency.

For example, the processor may determine the kinetic energy stored in the rotating components of generator units as twice a product of the inertia (i.e., the system inertia time constant), a system rated power, the nominal frequency value, and the system frequency deviation. When a power deficit occurs, the rotors decelerate automatically due to the power imbalance. The kinetic energy stored in the rotating components of the generator units is automatically released, and the released kinetic energy is instantaneously converted into electromagnetic power to enable inertia to provide kinetic energy for frequency regulation.

Mechanical power may represent the work done per unit time by the rotation of the generator unit's rotor.

In some embodiments, the generator units may change their mechanical power in various ways.

For example, for a thermal power unit, it may detect the frequency deviation via a speed governor, automatically adjust an opening degree of a high-pressure control valve, thereby changing a steam flow entering a turbine, and thus altering the mechanical power.

As another example, for a wind power unit, it may control a rotational speed of wind turbine blades, thereby changing wind energy captured by the blades, and consequently adjusting the mechanical power.

The unit start-stop decisions refer to time-series decisions regarding the start-up and shutdown of each unit.

In some embodiments, based on a load forecast, a wind/photovoltaic power forecast, a unit parameter, and the safety threshold, the processor may determine the unit start-stop decisions using a two-stage robust unit commitment optimization model.

For more details on the two-stage robust unit commitment optimization model, please refer to the relevant description for Step 120 in FIG. 3.

The frequency regulation power refers to a reserve capacity additionally reserved and dynamically released by generator units to participate in frequency regulation.

In some embodiments, the generating power and the frequency regulation power may be obtained by solving the two-stage robust unit commitment optimization model.

The quasi-steady-state frequency refers to a stable value of the frequency when dynamic balance is achieved after the primary frequency regulation ends and the primary frequency regulation reserve capacities of all generator units have been fully released.

In some embodiments, under a power deficit disturbance, at a moment when the primary frequency regulation reserve capacity is fully released, the processor may determine the quasi-steady-state frequency based on the power deficit, a load damping coefficient, a speed droop coefficient of each unit's governor, and the nominal frequency value.

For example, under a power deficit disturbance, at the moment when the primary frequency regulation reserve capacity is fully released, the processor may determine a sum of reciprocals of the speed droop coefficients of the units' governors and the load damping coefficient. The processor may then add the nominal frequency value to a ratio of the power deficit to the sum to obtain the quasi-steady-state frequency.

The nominal frequency value refers to a rated frequency value specified for normal system operation.

In some embodiments, the secondary frequency regulation uses an Automatic Generation Control (AGC) system to gradually release the secondary frequency regulation reserve capacity, eliminating a quasi-steady-state frequency deviation and restoring the frequency to a system nominal frequency. The AGC system refers to an automated system that achieves closed-loop control of the system frequency and tie-line power deviations by automatically adjusting the active power output of generator units.

For example, at time t=20, after primary frequency regulation, the system frequency stabilizes at a quasi-steady-state frequency of 49.7 Hz (below the threshold of 49.5 Hz). AGC initiates secondary frequency regulation, calculates an accumulated frequency deviation using a preset integral gain K_i=0.2, sends commands to thermal unit G1 to release 45 MW of secondary reserve, to wind unit W1 to release 20 MW, to distribution network unit DG1 to release 15 MW, and to PV1 to release 15 MW. After continuous regulation for 60 seconds, the frequency is restored to 50 Hz. The integrated value of the accumulated secondary frequency regulation frequency deviation is −0.8, satisfying the constraint A_min≤∫Δf(t)dt≤A_max.

In some embodiments of the present disclosure, by clearly delineating the three-stage dynamic process of the inertia response, the primary frequency regulation, and the secondary frequency regulation, the behavior of units in each stage and the timing of releasing frequency regulation resources are precisely defined. Thermal power units, wind power units, distributed generators, and photovoltaic units are integrated into a full-process frequency support system, providing an accurate physical and temporal foundation for constructing full-process frequency security constraints that span pre-, during-, and post-disturbance periods.

The full-process frequency security constraints refer to the limiting requirements imposed on the entire dynamic frequency response process.

In some embodiments, the full-process frequency security constraints include primary frequency regulation security constraints and secondary frequency regulation security constraints.

In some embodiments, the processor may construct the full-process frequency security constraints for the three stages of the inertia response, the primary frequency regulation, and the secondary frequency regulation.

The primary frequency regulation security constraints refer to a set of constraints that ensure the frequency does not fall below the safety threshold.

In some embodiments, the primary frequency regulation security constraints may include a Rate of Change of Frequency (RoCoF) constraint, a frequency nadir constraint, and a quasi-steady-state frequency constraint.

The Rate of Change of Frequency (RoCoF) constraint refers to the constraint that limits the rate of system frequency decline at the instant a power deficit occurs.

In some embodiments, the RoCoF constraint includes: when a power deficit begins to occur in the transmission and distribution network system, the system frequency deviation Δfₜ≈0. At this time, no units in the transmission and distribution network system have taken action. The system Rate of Change of Frequency (RoCoF) must satisfy ta maximum allowable requirement, and the system inertia time constant is jointly determined by the inertia time constants of all dispatchable frequency regulation resources within the system. The RoCoF constraint is expressed as:

$$RoCoF = \frac{\partial Δ {f}_{t}}{\partial t} = \frac{\vert Δ {P}_{L , t} \vert \cdot {f}_{0}}{2 {H}_{g , t}} \leq {RoCoF}^{max}$$

wherein, RoCoF denotes the system Rate of Change of Frequency (RoCoF); Δfₜ denotes system frequency deviation after an occurrence of a power deficit at a time t; f₀ denotes the system nominal frequency; ΔP_{L,t} denotes a system power deficit; H_{g,t} denotes a system inertia time constant at the time t; RoCoF^{max} denotes the maximum allowable requirement of the system RoCoF; t=0 represents the time when a power deficit begins to occur in the transmission and distribution network system.

The maximum allowable requirement refers to an upper limit threshold for the system RoCoF when a power deficit occurs.

The inertia time constant is a physical parameter characterizing the amount of kinetic energy stored in a generator unit. For example, the inertia time constant may be a ratio of the rotor stored energy to the rated power of the generator unit at its rated capacity. The system inertia time constant refers to a weighted aggregate value of the inertia time constants corresponding to all operating frequency regulation resources in the transmission and distribution network system under the current operating condition. In some embodiments, the processor may determine a weighted sum of the inertia time constants corresponding to each operating frequency regulation resource under the current operating condition as the system inertia time constant.

The frequency nadir constraint refers to a constraint that limits a lowest point to which the system frequency falls after the combined action of the inertia response and the primary frequency regulation.

In some embodiments, the frequency nadir constraint includes: the inertia response and the primary frequency regulation jointly act to cause the system frequency to decrease to the frequency nadir. During this process, each unit is required to reserve a primary frequency regulation reserve capacity to participate in the primary frequency regulation so as to prevent the system frequency deviation after the occurrence of the power deficit at the time t from exceeding a given safety threshold. The frequency nadir constraint is expressed as:

$$\vert Δ {f}_{nadir , t} \vert = \frac{2 {R}_{t}^{P} {H}_{g , t}}{{{T}_{d}^{P} ( {DP}_{t}^{D} )}^{2}} log ( \frac{2 {R}_{t}^{P} {H}_{g , t}}{{T}_{d}^{P} {DP}_{t}^{D} Δ {P}_{L , t}^{′} + 2 {R}_{t}^{P} {H}_{g , t}} ) + \frac{Δ {P}_{L , t}^{′}}{{DP}_{t}^{D}} + Δ {f}_{DB} \leq Δ {f}^{max}$$

wherein |Δf_{nadir,t}| denotes the system frequency deviation at the time t;

$${R}_{t}^{P}$$

denotes the sum of primary frequency regulation reserve capacities of the transmission and distribution network system at the time t;

$${T}_{d}^{P}$$

denotes a response time of the primary frequency regulation of the transmission and distribution network system; D denotes a load damping coefficient;

$${P}_{t}^{D}$$

denotes a system load;

$$Δ {P}_{L , t}^{′}$$

denotes a power deficit of the transmission and distribution network system when entering the inertia response at the time t; Δf_{DB} denotes a frequency dead band; Δf^{max} denotes the given safety threshold.

The response time of the primary frequency regulation refers to a time window required from when the frequency deviation exceeds the dead band until the primary frequency regulation reserve capacity is fully released.

The load damping coefficient is a physical parameter that characterizes the automatic adjustment of load power with changes in the system frequency.

The system load may also be referred to as the overall load of the transmission and distribution network system.

The frequency dead band refers to a set range within which the generator unit governor does not respond to minor frequency deviations.

The given safety threshold may also be referred to as the safety threshold.

The quasi-steady-state frequency constraint refers to a constraint that limits the stabilized system frequency value after the primary frequency regulation reserve is fully released.

In some embodiments, the quasi-steady-state frequency constraint includes: when the primary frequency regulation reserve capacities of all units in the transmission and distribution network system are fully released, the system frequency is maintained at the quasi-steady-state frequency f_{qss}, and the quasi-steady-state frequency deviation at the time t is required to be controlled within a maximum allowable range

$$Δ {f}_{qss}^{max}$$

for the transmission and distribution network system. The quasi-steady-state frequency constraint is expressed as:

$$\vert Δ {f}_{qss , t}^{} \vert = \frac{Δ {P}_{L , t} - {R}_{t}^{P}}{{DP}_{t}^{D}} \leq Δ {f}_{qss}^{max} ,$$

wherein |Δf_{qss,t}| denotes the quasi-steady-state frequency deviation at the time t.

The quasi-steady-state frequency refers to a stable value of the system frequency when dynamic equilibrium is reached after primary frequency regulation ends and the primary frequency regulation reserve capacities of all generator units have been fully released.

The quasi-steady-state frequency deviation refers to a difference between the quasi-steady-state frequency and the system nominal frequency.

The secondary frequency regulation security constraints refer to a set of constraints established to precisely restore the frequency to its rated value and avoid excessive deviation.

In some embodiments, the secondary frequency regulation security constraints include a secondary frequency regulation reserve capacity constraint and a secondary frequency regulation frequency deviation accumulation constraint.

The secondary frequency regulation reserve capacity constraint refers to a constraint relationship among the secondary frequency regulation reserve capacity, the primary frequency regulation reserve capacity, and the power deficit.

In some embodiments, the secondary frequency regulation reserve capacity constraint includes: to restore the frequency to the nominal frequency value by the end of the secondary frequency regulation, a sum of the secondary frequency regulation reserve capacities and the primary frequency regulation reserve capacities of the units in the transmission and distribution network system is not less than the system power deficit. The secondary frequency regulation reserve capacity constraint is expressed as:

$${R}_{t}^{P} + {R}_{t}^{S} \geq Δ {P}_{L , t} ;$$

wherein,

$${R}_{t}^{S}$$

denotes a sum of the secondary frequency regulation reserve capacities of the units in the transmission and distribution network system at the time t.

The secondary frequency regulation frequency deviation accumulation constraint refers to a constraint on the system frequency deviation during the secondary frequency regulation process.

In some embodiments, the secondary frequency regulation frequency deviation accumulation constraint includes: an accumulated amount of secondary frequency regulation frequency deviation in the transmission and distribution network system is required to be maintained within a predetermined range so as to avoid excessive deviation of the system frequency from the nominal frequency value at a beginning of the secondary frequency regulation. The secondary frequency regulation frequency deviation accumulation constraint is expressed as:

$${SFR}^{min} \leq ( Δ {P}_{L , t} - {R}_{t}^{P} - {R}_{t}^{S} ) \frac{{t}^{s} - 2 {σ}_{2}}{20 {σ}_{1}} \leq {SFR}^{max} ,$$

wherein t^{s} denotes an ending time of the secondary frequency regulation frequency deviation in the transmission and distribution network system; σ₁ denotes a system frequency deviation coefficient; σ₂ denotes an integral control parameter; SFR^{max} and SFR^{min} denote an upper limit and a lower limit of the accumulated secondary frequency regulation frequency deviation in the transmission and distribution network system, respectively.

The ending time of the secondary frequency regulation frequency deviation refers to a time window of the secondary frequency regulation process. In some embodiments, the processor may determine a complete regulation duration from the end of the primary frequency regulation (when the frequency reaches its nadir) to the restoration of the frequency to the rated value (Δfₜ→0) as the ending time of the secondary frequency regulation frequency deviation.

The system frequency deviation coefficient refers to a physical parameter that characterizes a strength of a relationship between the system frequency deviation and the power deficit.

The integral control parameter refers to a parameter used to eliminate steady-state frequency error.

The accumulated amount of secondary frequency regulation frequency deviation refers to an integral value of the system frequency deviation over time during the secondary frequency regulation process.

In some embodiments, the constraints of the two-stage robust unit commitment optimization model for the transmission and distribution network, based on the full-process frequency security constraints constructed in step 110, also consider conventional grid operation constraints. The conventional grid operation constraints include: a power balance constraint, a unit operation constraint, and a network security constraint. The power balance constraint ensures power balance at the nodes of the transmission and distribution networks. The unit operation constraint includes upper and lower limits of unit output, up and down ramp rate limits, minimum up and down time limits, etc. The network security constraint includes power flow equations, transmission line power limits, upper and lower limits of node voltage (handled using second-order cone relaxation), and tie-line transmission limits.

The calculation formulas for the conventional grid operation constraints are as follows:

$${\sum }_{i ∈ a} {P}_{i , t} + {\sum }_{w ∈ a} {P}_{w , t} - {\sum }_{tranl ∈ a} {P}_{tranl , t} - {\sum }_{e ∈ a} {P}_{e , t}^{TD} = {\sum }_{∀ b ∈ Ω ( : , a )} ( {f}_{ba , t} - {f}_{ab , t} )$$

$$\{ \begin{matrix}{f}_{ab , t} = {B}_{ab} ( {θ}_{a , t} - {θ}_{b , t} ) \\ \vert {f}_{ab , t} \vert \leq {F}_{flow , ab}^{max} \\ - π \leq {θ}_{a , t} \leq π \\ {θ}_{r , t} = 0\end{matrix}$$

$$\{ \begin{matrix}{\sum }_{k = t}^{t + {T}_{on , i} - 1} {u}_{i , k} \geq {T}_{on , i} ( {u}_{i , t} - {u}_{i , t - 1} \\ {\sum }_{k = t}^{t + {T}_{off , i} - 1} ( 1 - {u}_{i , k} ) \geq {T}_{off , i} ( {u}_{i , t - 1} - {u}_{i , t} )\end{matrix}$$

$$\{ \begin{matrix}{u}_{i , t} - {u}_{i , t - 1} = {su}_{i , t} - {sv}_{i , t} \\ {su}_{i , t} + {sv}_{i , t} \leq 1\end{matrix}$$

$$\{ \begin{matrix}{P}_{i , t} + {R}_{i , t}^{P} + {R}_{i , t}^{S} - {P}_{i , t - 1} - {R}_{i , t - 1}^{P} - {R}_{i , t - 1}^{S} \leq {ramp}_{i}^{u} \\ {P}_{i , t} + {R}_{i , t}^{P} + {R}_{i , t}^{S} - {P}_{i , t - 1} - {R}_{i , t - 1}^{P} - {R}_{i , t - 1}^{S} \geq - {ramp}_{i}^{d}\end{matrix}$$

$${u}_{i , t} \cdot {P}_{i}^{min} \leq {P}_{i , t} \leq {u}_{i , t} \cdot {P}_{i}^{max} - {R}_{i , t}^{P} - {R}_{i , t}^{S}$$

$${P}_{w , t}^{min} \leq {P}_{w , t} \leq {P}_{w , t}^{un} - {R}_{w , t}^{P} - {R}_{w , t}^{S}$$

$$0 \leq {R}_{i , t}^{P} + {R}_{i , t}^{S} \leq {u}_{i , t} \cdot {R}_{i}^{max}$$

$$0 \leq {R}_{w , t}^{P} + {R}_{w , t}^{S} \leq {R}_{w , t}^{max}$$

$${R}_{i , t}^{P} \geq 0$$

$${R}_{i , t}^{S} \geq 0$$

$${R}_{w , t}^{P} \geq 0$$

$${R}_{w , t}^{S} \geq 0$$

$$\{ \begin{matrix}{P}_{j , n , t} + {P}_{p , n , t} + {\sum }_{m ∈ {ϕ}_{1} ( : , n )} ( {P}_{mn , t} - {I}_{mn , t}^{2} {r}_{mn} ) + {P}_{e , n , t}^{TD} = {\sum }_{d ∈ {ϕ}_{2} ( n , : )} {P}_{nd , t} + {P}_{distl , n , t} \\ {Q}_{j , n , t} + {Q}_{p , n , t} + {\sum }_{m ∈ {ϕ}_{1} ( : , n )} ( {Q}_{mn , t} - {I}_{mn , t}^{2} {x}_{mn} ) + {Q}_{e , n , t}^{TD} = {\sum }_{d ∈ {ϕ}_{2} ( n , : )} {Q}_{nd , t} + {Q}_{distl , n , t}\end{matrix}$$

$${U}_{n , t}^{2} = {U}_{m , t}^{2} - 2 ( {r}_{mn} {P}_{mn , t} + {x}_{mn} {Q}_{mn , t} ) + ( {r}_{mn}^{2} + {x}_{mn}^{2} ) {I}_{mn , t}^{2}$$

$${U}_{n}^{min} \leq {U}_{n , t} \leq {U}_{n}^{max}$$

$$‖ \begin{matrix}2 {P}_{mn , t} \\ 2 {Q}_{mn , t} \\ {I}_{mn , t}^{2} - {U}_{m , t}^{2}\end{matrix} ‖ \leq {I}_{mn , t}^{2} + {U}_{m , t}^{2}$$

$${P}_{j}^{min} \leq {P}_{j , t} \leq {P}_{j}^{max} - {R}_{j , t}^{P} - {R}_{j , t}^{S}$$

$${P}_{p , t}^{min} \leq {P}_{p , t} \leq {P}_{p , t}^{un} - {R}_{p , t}^{P} - {R}_{p , t}^{S}$$

$$0 \leq {R}_{j , t}^{P} + {R}_{j , t}^{S} \leq {R}_{j}^{max}$$

$$0 \leq {R}_{p , t}^{P} + {R}_{p , t}^{S} \leq {R}_{p , t}^{max}$$

$${R}_{j , t}^{P} \geq 0$$

$${R}_{j , t}^{S} \geq 0$$

$${R}_{p , t}^{P} \geq 0$$

$${R}_{p , t}^{S} \geq 0$$

$${P}_{e}^{TD , min} + {R}_{j , t}^{P} + {R}_{j , t}^{S} + {R}_{p , t}^{P} + {R}_{p , t}^{S} \leq {P}_{e , t}^{TD} \leq {P}_{e}^{TD , max} ,$$

wherein P_{i,t} and P_{w,t} denote the active power output of the thermal power unit i and active power output of the wind power unit w at the time t, respectively; tranl denotes a transmission network load at a node a; P_{tranl,t} denotes a predicted transmission network load at the time t;

$${P}_{e , t}^{TD}$$

denotes a transmission capacity of a tie-line between a transmission network and a distribution network at the time t, where e denotes a distribution network connected to the node a; Ω(:,a) denotes a set of sending-end nodes connected to the node a, and b is any node in Ω(:,a); f_{ab,t} and f_{ba,t} denote a transmission power of a line ab and a transmission powers of a line ba; B_{ab} denotes a susceptance of the line ab; θ_{a,t}, θ_{b,t}, θ_{r,t} denote phase angles of the node a, the node b, and a reference node at the time t;

$${F}_{flow , ab}^{max}$$

denotes an upper limit of the transmission power of the line ab; T_{on,i} and T_{off,i} respectively denote a minimum start-up time and a minimum shut-down time of the thermal power unit i; u_{i,t}, u_{i,t-1}, and u_{i,k} denote start-stop states of the thermal power unit i at the time t, a time t−1, and a time k, respectively, where a value of 1 indicates in operation and a value of 0 indicates shut-down;

$${P}_{i , t - 1} , {R}_{i , t - 1}^{P} , {R}_{i , t - 1}^{S}$$

denote an active power output, a primary frequency regulation reserve capacity, and a secondary frequency regulation reserve capacity of the thermal power unit i at the time t−1, respectively;

$${ramp}_{i}^{u}$$

$$and$$

$${ramp}_{i}^{d}$$

denote an upward ramping rate and a downward ramping rate of the thermal power unit i, respectively;

$${P}_{i}^{max}$$

$$and$$

$${P}_{i}^{min}$$

denote an upper output limit and a lower output limit of the thermal power unit i, respectively;

$${P}_{w , t}^{un}$$

$$and$$

$${P}_{w , t}^{min}$$

denote an upper output limit and a lower output limit of the wind power unit w, respectively;

$${R}_{i}^{max}$$

denote a maximum frequency regulation reserve capacity of the thermal power unit i;

$${R}_{w , i}^{max}$$

denotes a maximum frequency regulation reserve capacity of the wind power unit w; P_{j,n,t} and P_{p,n,t} respectively denote active powers injected into a node n by the distributed generator unit j and the photovoltaic unit p at the time t; Q_{j,n,t} and Q_{p,n,t} respectively denote reactive powers injected into the node n by the distributed generator unit j and the photovoltaic unit p at the time t; P_{mn,t} and Q_{mn,t} respectively denote an active power and a reactive power injected from a node m to the node n at the time t; P_{nd,t} and Q_{nd,t} respectively denote an active power and a reactive power output from the node n to a node d; Φ₁(n,:) denotes a set of sending-end nodes for which the node n is a terminal node, and Φ₂(n,:) denotes a set of terminal nodes for which the node n is a sending-end node, where d denotes any terminal node for which the node n is the sending-end node; I_{mn,t} denotes a current flowing through a line mn at the time t; rₘₙ and xₘₙ respectively denote a resistance and a reactance of the line mn;

$${P}_{e , n , t}^{TD}$$

$$and$$

$${Q}_{e , n , t}^{TD}$$

respectively denote an active power and a reactive power transmitted through a tie-line between the transmission network and the distribution network into the node n at the time t; P_{distl,n,t} and Q_{distl,n,t} denote a predicted active load and a predicted reactive load at the node n at the time t, respectively; U_{m,t} and U_{n,t} denote a voltage of the node m and a voltage of the node n at the time t, respectively;

$${U}_{n}^{max}$$

$$and$$

$${U}_{n}^{min}$$

denote an upper voltage limit and a lower voltage limit of the node n, respectively;

$${P}_{j}^{max}$$

$$and$$

$${P}_{j}^{min}$$

denote an upper output limit and a lower output limit of the distributed generator unit j, respectively; P_{p,t} denotes an active power output of the photovoltaic unit p;

$${P}_{p , t}^{un}$$

$$and$$

$${P}_{p , t}^{min}$$

denote an upper output limit and a lower output limit of the photovoltaic unit p, respectively;

$${R}_{j}^{max}$$

denote a maximum frequency regulation reserve capacity of the distributed generator unit j;

$${R}_{p , t}^{max}$$

denote a maximum frequency regulation reserve capacity of the photovoltaic unit p;

$${P}_{e}^{TD , min}$$

$$and$$

$${P}_{e}^{TD , max}$$

respectively denote a lower transmission capacity limit and an upper transmission capacity limit of the tie-line between the transmission network and the distribution network.

In 120, constructing an uncertainty set of wind power output and an uncertainty set of photovoltaic power output in an interval form by considering uncertainty of wind power output and uncertainty of photovoltaic power output, establishing a two-stage robust unit commitment optimization model of the transmission and distribution network considering the full-process frequency response with a min-max-min structure, and minimizing a sum of start-stop costs, generation costs, primary frequency regulation reserve costs, and secondary frequency regulation reserve costs as an objective.

The wind power output may also be referred to as wind power generation power. The photovoltaic power output may also be referred to as photovoltaic power.

Uncertainty refers to the physical characteristic where deviations exist between the actual output power of generator units and their predicted values due to the randomness of weather conditions and forecast errors. Uncertainty may include the uncertainty of wind power output and the uncertainty of photovoltaic power output.

In some embodiments, the uncertainty set of wind power output and the uncertainty set of photovoltaic power output are expressed as:

$$U = [ {Un}^{W} , {Un}^{P} ] = \{ \begin{matrix}{P}_{w , t}^{un} = {P}_{w , t}^{max} - {α}_{w , t}^{-} {Δ P}_{w , t} \\ {P}_{p , t}^{un} = {P}_{p , t}^{max} - {α}_{p , t}^{-} {Δ P}_{p , t} \\ {\sum }_{t ∈ T} {α}_{w , t}^{-} \leq {Γ}_{w} , {\sum }_{t ∈ T} {α}_{p , t}^{-} \leq {Γ}_{p} \\ {α}_{w , t}^{-} \leq 1 , {α}_{p , t}^{-} \leq 1 \\ {α}_{w , t}^{-} , {α}_{p , t}^{-} ∈ \{ 0 , 1 \}\end{matrix} ,$$

wherein U denotes a set including the uncertainty set of wind power output and the uncertainty set of photovoltaic power output; Un^{W} and Un^{P} denote the uncertainty set of wind power output and the uncertainty set of photovoltaic power output, respectively;

$${P}_{w , t}^{u n} and {P}_{p , t}^{u n}$$

denote an uncertainty-adjusted power of the wind power output and an uncertainty-adjusted power of the photovoltaic power output, respectively;

$${P}_{w , t}^{max} and {P}_{p , t}^{max}$$

denote a predicted wind power output and a predicted photovoltaic power output, respectively; ΔP_{w,t} and ΔP_{p,t} denote a maximum allowable fluctuation range of the wind power output and a maximum allowable fluctuation range of the photovoltaic power output, respectively;

$${α}_{w , t}^{-} and {α}_{p , t}^{-}$$

respectively denote binary variables indicating, at the time t, whether the wind power output and the photovoltaic power output reach an interval boundary; Γ_{w} and Γₚ respectively denote an introduced wind uncertainty level and an introduced photovoltaic uncertainty level, representing a total count of time periods at which the wind power output and the photovoltaic power output reach the interval boundary; T denotes a total count of scheduling time periods.

When Γ_{w}=Γₚ=0, the impact of the uncertainty of wind power output and the uncertainty of photovoltaic power output on the transmission and distribution network system is not considered, but this approach carries certain risks. When Γ_{w}=Γₚ=24, the wind power output and the photovoltaic power output take the interval boundary values at all times, resulting in overly conservative optimization results.

It may be understood that taking the lower bound of the uncertainty sets of wind and photovoltaic power outputs represents minimum values of wind and photovoltaic power generation under the most adverse conditions, satisfying the “worst-case output” sought by the two-stage robust unit commitment optimization model.

The min-max-min structure is a common optimization problem framework, typically used to address problems involving multiple decision-makers and multiple objectives. In this structure, there exist multiple decision-makers (also referred to as players) and multiple objective functions. Each decision-maker aims to minimize their own objective function while maximizing the objective functions of others.

The two-stage robust unit commitment optimization model is an optimization technique applied within the min-max-min structure, designed to handle uncertainty and risk. The two-stage robust unit commitment optimization model divides the problem into two stages, each with its own optimization subproblem.

A first stage is a robust optimization problem. The first stage considers uncertain factors and seeks a robust solution, which minimizes an objective function value within a range of uncertainty. The objective of this stage is to minimize a maximum objective function value of a second stage.

The second stage is a maximization problem. Building upon the solution from the first stage, the second stage searches for an optimal solution that maximizes the objective function value. The objective of this stage is to maximize the objective function value of the second stage.

The mathematical representation of the two-stage robust unit commitment optimization model is as follows:
The first stage: minimize f₁(x) subject to g₁(x, w)≤0, x∈X;
The second stage: maximize f₂(x, y) subject to g₂(x, y)≤0, y∈Y;
   where f₁(x) and f₂(x, y) are the objective functions of the first and second stages, respectively; g₁(x, w) and g₂(x, y) are constraints of the first and second stages, respectively; x and y are decision variables; X and Y are feasible domains of the decision variables; and w is an uncertain parameter.

It may be understood that the solution manner for the two-stage robust unit commitment optimization model typically involves techniques from robust optimization and maximization problems, such as robust optimization theory, best response, and Nash equilibrium concepts. By iteratively solving the optimization problems of the first and second stages, the solution to the min-max-min structure can be gradually approximated, while accounting for uncertain factors and risks.

The objective function refers to a linearly weighted sum expression aimed at minimizing a total operating cost of the transmission and distribution network system.

In some embodiments, the objective function of the two-stage robust unit commitment optimization model for the transmission and distribution network is:

$$\{ \begin{matrix}min {F}_{1} + max min ( {F}_{2} + {F}_{3} ) \\ {F}_{1} = {\sum }_{i ∈ T G} {\sum }_{t ∈ T} ( {C}_{i}^{s u} s {u}_{i , t} + {C}_{i}^{s v} s {v}_{i , t} ) \\ {F}_{2} = {\sum }_{i ∈ TG} {\sum }_{t ∈ T} {C}_{i} {P}_{i , t} + {\sum }_{j ∈ D G} {\sum }_{t ∈ T} {C}_{j} {P}_{j , t} \\ \begin{matrix}{F}_{3} = {\sum }_{i ∈ TG} {\sum }_{t ∈ T} {C}_{i}^{P} {R}_{i , t}^{P} + {\sum }_{w ∈ T W} {\sum }_{t ∈ T} {C}_{w}^{P} {R}_{w , t}^{P} + \\ {\sum }_{j ∈ D G} {\sum }_{t ∈ T} {C}_{j}^{P} {R}_{j , t}^{P} + {\sum }_{p ∈ D P} {\sum }_{t ∈ T} {C}_{p}^{P} {R}_{p , t}^{P} +\end{matrix} \\ \begin{matrix}{\sum }_{i ∈ TG} {\sum }_{t ∈ T} {C}_{i}^{S} {R}_{i , t}^{S} + {\sum }_{w ∈ T W} {\sum }_{t ∈ T} {C}_{w}^{S} {R}_{w , t}^{S} + \\ {\sum }_{j ∈ D G} {\sum }_{t ∈ T} {C}_{j}^{S} {R}_{j , t}^{S} + {\sum }_{p ∈ D P} {\sum }_{t ∈ T} {C}_{p}^{S} {R}_{p , t}^{S}\end{matrix}\end{matrix}$$

wherein F₁ denotes a sum of start-stop costs of the thermal power units; F₂ denotes a sum of generation costs of the thermal power units and distributed generator units; F₃ denotes a sum of primary frequency regulation reserve costs and secondary frequency regulation reserve costs; T denotes a total count of scheduling time periods;

$${C}_{i}^{s u} and {C}_{i}^{s v}$$

denote a start-up cost and a shutdown cost of a thermal power unit i, respectively; su_{i,t} and sv_{i,t} denote a start-up state and a shutdown state of the thermal power unit i at the time t, respectively; Cᵢ and Cⱼ denote a generation cost of the thermal power unit i and a generation cost of a distributed generator unit j, respectively; P_{i,t} and P_{j,t} denote an active power output of the thermal power unit i and an active power output of the distributed generator unit j at the time t, respectively;

$${C}_{i}^{P} , {C}_{w}^{P} , {C}_{j}^{P} , and {C}_{p}^{P}$$

denote a primary frequency regulation reserve cost of the thermal power unit i, a primary frequency regulation reserve cost of a wind power unit w, a primary frequency regulation reserve cost of the distributed generator unit j, and a primary frequency regulation reserve cost of a photovoltaic unit p, respectively;

$${C}_{i}^{S} , {C}_{w}^{S} , {C}_{j}^{S} , and {C}_{p}^{S}$$

denote a secondary frequency regulation reserve cost of the thermal power unit i, a secondary frequency regulation reserve cost of the wind power unit w, a secondary frequency regulation reserve cost of the distributed generator unit j, and a secondary frequency regulation reserve cost of the photovoltaic unit p, respectively;

$${R}_{i , t}^{P} , {R}_{w , t}^{P} , {R}_{j , t}^{P} and {R}_{p , t}^{P}$$

denote a primary frequency regulation reserve capacity of the thermal power unit i, a primary frequency regulation reserve capacity of the wind power unit w, a primary frequency regulation reserve capacity of the distributed generator unit j, and a primary frequency regulation reserve capacity of the photovoltaic unit p at the time t, respectively;

$${R}_{i , t}^{S} , {R}_{w , t}^{S} , {R}_{j , t}^{S} and {R}_{p , t}^{S}$$

denote a secondary frequency regulation reserve capacity of the thermal power unit i, a secondary frequency regulation reserve capacity of the wind power unit w, a secondary frequency regulation reserve capacity of the distributed generator unit j, and a secondary frequency regulation reserve capacity of the photovoltaic unit p at the time t, respectively; TG, TW, DG, and DP denote a set of thermal power units, a set of wind power units, a set of distributed generator units, and a set of photovoltaic units participating in a frequency regulation process, respectively.

In some embodiments of the present disclosure, by explicitly incorporating the start-stop costs, the generation costs, and the primary and secondary frequency regulation reserve costs of four types of units, a comprehensive cost evaluation system is constructed. This drives the optimization model to prioritize the dispatch of low-cost frequency regulation resources, achieving a balance between economic efficiency and frequency regulation capability, and providing a quantitative decision-making basis for robust scheduling.

The objective function value refers to a calculated result of the objective function.

The start-stop cost refers to a one-time expense incurred when a generator unit transitions from the shutdown state to the operating state or from the operating state to the shutdown state. The start-stop cost of a generator unit may include a start-up cost (i.e., the expense incurred when the generator unit transitions from the shutdown state to the operating state), and a shutdown cost (i.e., the expense incurred when the generator unit transitions from the operating state to the shutdown state).

The generation cost refers to a variable cost incurred by a generator unit during its operation for steady-state power generation. In some embodiments, the higher the power output of the generator unit, the greater the generation cost.

In some embodiments of the present disclosure, by constructing uncertainty set of wind power output and the uncertainty set of photovoltaic power output in the interval form, the fluctuation range of renewable energy can be characterized without requiring precise probability distributions. Utilizing the uncertainty level Γ enables controllable conservativeness, effectively balancing security and economy. This approach provides a computable and adjustable mathematical foundation for two-stage robust optimization, avoiding the drawbacks of traditional stochastic optimization, such as high computational burden and difficulty in determining probability distributions.

In 130, converting, by using a column-and-constraint generation (C&CG) algorithm and a strong duality theory, the two-stage robust unit commitment optimization model of the transmission and distribution network into a mixed-integer second-order cone programming (MISOCP) model, and iteratively solving the MISOCP model until an upper bound and a lower bound of the objective function converge, thereby obtaining an optimal unit scheduling scheme under a worst-case scenario of the wind power output and the photovoltaic power output.

The C&CG algorithm refers to an exact decomposition algorithm used to solve two-stage robust optimization problems.

The strong duality theory refers to a theory describing that when constraint qualifications (such as Slater's condition) are satisfied, an optimal value of a primal problem equals an optimal value of its dual problem.

The MISOCP model refers to a convex optimization model containing integer variables and second-order cone constraints.

In some embodiments, the processor may decompose the two-stage robust unit commitment optimization model into a master-subproblem iterative solution using the C&CG algorithm. By employing strong duality theory, the bilevel max-min structure of the subproblem is transformed into a single-level max problem, thereby equivalently converting the two-stage robust unit commitment optimization model into the MISOCP model that can be directly handled by commercial solvers.

In some embodiments, the processor may decompose the objective function of the two-stage robust unit commitment optimization model for the transmission and distribution network into a master problem (MP) and a subproblem (SP). A transformed objective function and transformed constraints are expressed in a matrix form. The master problem is represented as:

$$\{ \begin{matrix}{min}_{x} {c}_{M P}^{T} x + η \\ s . t . Ax \leq d , η \geq {c}_{S P}^{T} {y}_{l} \\ B {y}_{l} + f = 0 \\ E {y}_{l} \leq g \\ Fx + {Gy}_{l} \leq z \\ {Hy}_{l} + K {h}_{l} \leq p \\ {‖ {O}_{m} {y}_{l} ‖}_{2} \leq {q}_{m}^{T} {y}_{l}\end{matrix}$$

wherein x denotes a decision variable;

$${c}_{M P}^{T}$$

x denotes a coefficient vector related to the variable x in the objective function;

$${c}_{M P}^{T}$$

denotes a transpose of a cost coefficient matrix of the master problem; η denotes a relaxation variable of the subproblem;

$${c}_{SP}^{T}$$

denotes a transpose of a cost coefficient matrix of the subproblem; yₗ denotes a solution of the subproblem after an l-th iteration; hₗ denotes a worst-case scenario of the wind power output and the photovoltaic power output after the l-th iteration; Oₘ denotes a variable coefficient matrix corresponding to a branch m with the node n as a terminal node in a second-order cone constraint; qₘ^{T} denotes a transpose of a constraint constant matrix corresponding to the branch branch m with the node n as the terminal node in the second-order cone constraint; A, B, E, F, G, H, K, and O denote corresponding variable coefficient matrices; and d, f, g, z, p, and q denote corresponding constraint constant matrices.

The subproblem is expressed as:

$$\{ \begin{matrix}{max}_{h ∈ U} {min}_{y ∈ ψ ( x , h )} {c}_{S P}^{T} y \\ s . t . By + f = 0 ( λ ) \\ Ey \leq g ( γ ) \\ F {x}_{l}^{*} + G y \leq z ( μ ) \\ Hy + Kh \leq p ( ζ ) \\ {‖ {O}_{m} {y}_{l} ‖}_{2} \leq {q}_{m}^{T} y ( {π}_{1} , {π}_{2} )\end{matrix} ;$$

wherein y denotes a set of second-stage optimization variables; U denotes the set including the uncertainty set of wind power output and the uncertainty set of photovoltaic power output; h denotes a set of uncertain wind power output and photovoltaic power output; ψ(x, h) denotes a feasible region of y after determining x and h;

$${x}_{l}^{*}$$

denotes a solution of the master problem after the l-th iteration; and λ, γ, μ, ζ, π₁, and π₂ denotes dual variables corresponding to constraints of the subproblem.

Since the max-min bilevel model in the subproblem cannot be directly solved by a solver, an inner-layer minimization problem is converted into a dual maximization problem by using the strong duality theory and a big-M technique, and the dual maximization problem is combined with an outer layer to obtain a single-layer maximization model as follows:

$$\{ \begin{matrix}\begin{matrix}{max}_{h ∈ U , λ , γ , μ , ζ , {π}_{1} , {π}_{2}} ( {f}^{T} λ - {g}^{T} γ - {( {Fx}_{i}^{*} - z )}^{T} μ - \\ {( K \cdot {p}^{p r e} )}^{T} ζ + {( K \cdot Δ P )}^{T} \cdot {A}^{-} + {p}^{T} ζ )\end{matrix} \\ s . t . {c}_{S P} + {B}^{T} λ + {E}^{T} γ + {G}^{T} μ + {H}^{T} ζ + {\sum }_{m} ( {O}_{m}^{T} {π}_{1 , m} - {q}_{m}^{T} {π}_{2 , m} ) = 0 \\ {‖ {π}_{1 , m} ‖}_{2} \leq {π}_{2 , m} \\ γ \geq 0 , μ \geq 0 , ζ \geq 0 , {π}_{2} \geq 0 \\ - {M}_{2} {α}^{-} \leq {A}^{-} \leq {M}_{2} {α}^{-} \\ - {M}_{2} ( 1 - {α}^{-} ) \leq {A}^{-} - ζ \leq {M}_{2} ( 1 - {α}^{-} ) \\ {α}^{-} \leq 1 \\ {α}^{-} ∈ \{ 0 , 1 \}\end{matrix} ;$$

wherein P^{pre} denotes a set of predicted wind power output and predicted photovoltaic power output; ΔP denotes a set of maximum allowable fluctuation deviations of wind power output and photovoltaic power output; π_{1,m} and π_{2,m} denote a dual variable corresponding to a left-hand side and a dual variable corresponding to a right-hand side of the second-order cone constraint, respectively; α⁻ denote a set of binary variables indicating whether wind power output and photovoltaic power output at the time t reach interval boundaries; M₂ denotes an artificial variable introduced by the big-M technique; and A⁻ denotes an introduced continuous auxiliary variable.

The method allows the master problem (MP) to make preliminary decisions without considering uncertainty. The subproblem (SP) then identifies the worst-case scenario based on the MP's decisions, enabling the MP to continuously introduce variables and constraints related to the SP. This process yields tighter upper and lower bounds for the original objective function value until the algorithm converges.

In some embodiments of the present disclosure, the difficult-to-solve min-max-min three-layer structure is decomposed into an iterative master-subproblem process using the C&CG algorithm. The strong duality theory is applied to transform the bilevel subproblem model into a single-level max problem, thereby equivalently converting it into the MISOCP model that can be efficiently handled by commercial solvers. This enables rapid convergence of the upper and lower bounds, ensures the acquisition of a globally optimal unit scheduling scheme, and significantly improves computational efficiency and the feasibility of robust optimization.

In some embodiments, the processor may execute the robust optimization unit commitment method for the transmission and distribution network at a predetermined interval: updating the uncertainty sets based on real-time meteorological information; and updating the active power output P_{i,t} of the thermal unit i, the start-up and shutdown state u_{i,t} of the thermal unit i, and the active power output P_{j,t} of the distributed generator unit j based on real-time measurement data and a correction coefficient.

The predetermined interval refers to a time period for system data refresh and recalculation. For example, the predetermined interval may be 15 minutes.

In some embodiments, the predetermined interval may be preset by technical personnel based on requirements.

The real-time meteorological information refers to information related to current weather conditions.

In some embodiments, the real-time meteorological information is time-series data and may include environmental parameters affecting renewable energy output at multiple time points within the previous predetermined interval, such as wind speed, solar irradiance, cloud thickness, etc.

In some embodiments, the processor may obtain the real-time meteorological information via an environmental sensor. Exemplary environmental sensors may include a photosensitive sensor, a wind measurement tower, a phased-array wind profiler radar, etc.

The uncertainty sets refer to mathematical sets describing all possible fluctuation ranges of the wind and photovoltaic power output.

In some embodiments, based on variation magnitudes of the environmental parameters in the real-time meteorological information, the processor may update predicted wind power output, the predicted photovoltaic power output, the maximum allowable fluctuation range of the wind power output, and the maximum allowable fluctuation range of the photovoltaic power output using a first preset lookup table, thereby completing the update of the uncertainty sets.

The variation magnitude refers to a difference between the environmental parameter at a subsequent time point and that at a preceding time point within the real-time meteorological information.

The first preset table may include a relationship between the variation magnitudes of various environmental parameters, the predicted photovoltaic power output, the predicted wind power output, the maximum allowable fluctuation range of the photovoltaic power output, and the maximum allowable fluctuation range of the wind power output. In some embodiments, the first preset table may be predefined by technical personnel based on experience.

For example, when the real-time meteorological information indicates that future wind speeds are trending toward stability, the predicted outputs of corresponding wind power units and photovoltaic units are reduced, and the maximum allowable fluctuation ranges of the photovoltaic and wind power output are decreased, thereby narrowing the uncertainty sets. Conversely, when meteorological information suggests that future wind speed data may increase, the predicted outputs of the wind power units and photovoltaic units are increased, and the maximum allowable fluctuation ranges of the photovoltaic and wind power output are maintained or expanded, thereby widening the uncertainty sets.

The real-time measurement data refers to data reflecting a physical operational state of the transmission network and active distribution network at the current moment.

For example, the real-time measurement data may include the system frequency, tie-line power, transmission network node load, distribution network node load, measured output of thermal power units, measured output of wind power units, measured output of distributed generator units, measured output of photovoltaic units, and unit start-stop state.

The tie-line power refers to the real-time active and reactive power transfer values on the physical connecting lines between the transmission network and the active distribution network.

The transmission network node load refers to the real-time active power consumption of high-voltage load nodes directly connected to the transmission network.

The distribution network node load refers to the real-time load demand at various nodes within the active distribution network.

The measured output of thermal power units refers to the actual active power currently being generated by each thermal power unit.

The measured output of wind power units refers to the actual active power currently being generated by each wind power unit.

The measured output of photovoltaic units refers to the actual active power currently being generated by each photovoltaic unit.

The measured output of distributed generator units refers to the current actual generation power of each distributed generator unit.

In some embodiments, the processor may obtain the real-time measurement data from electric meters via a communication interface.

The correction coefficient refers to a parameter used to adjust the weighting influence of the real-time measurement data on future predicted data.

In some embodiments, the correction coefficient may be pre-set by technical personnel based on experience.

In some embodiments, the correction coefficient is related to an average load factor of the units.

In some embodiments, the higher the average unit load factor is, the larger the correction coefficient is.

The average unit load factor refers to a ratio of the actual total output of all generator units to a total rated capacity. The generator units include all dispatchable power sources in the current transmission and distribution network, such as thermal power units, wind power units, distributed energy resources, and centralized renewable energy units. The actual total output refers to a sum of the actual active power outputs of all currently operating generator units at the current moment. The total rated capacity refers to a sum of the rated capacities of all dispatchable frequency regulation resources.

In some embodiments of the present disclosure, by linking the correction coefficient to the average unit load factor, the correction coefficient is increased when the average unit load factor rises. This gives greater weight to the real-time measurement data, enabling the updated scheduling scheme to closely follow actual fluctuations and reducing the risk of constraint violations. When the load factor decreases, the correction coefficient is reduced, increasing the relative weight of predicted data, thereby avoiding unnecessary frequent adjustments, minimizing excessive unit cycling, and achieving adaptive balancing of security and economic efficiency under different operating conditions.

In some embodiments, based on the real-time measurement data and the correction coefficient, the processor may update the active power output P_{w,t} of the wind unit w and the active power output P_{p,t} of the photovoltaic unit p to the sum of the unit outputs in the real-time measurement data—specifically, updating to the sum of the measured outputs of wind power units and photovoltaic units—in order to update the active power output P_{i,t} of the thermal unit i, the start-stop state u_{i,t} of the thermal unit i, and the active power output P_{j,t} of the distributed generator unit j.

In some embodiments, the processor may use the updated uncertainty sets and the updated values for the active power output P_{i,t} of the thermal unit i, the start-stop state u_{i,t} of the thermal unit i, and the active power output P_{j,t} of the distributed generator unit j as input parameters to replace the corresponding parameters in the original two-stage robust unit commitment optimization model, thereby completing the update of the two-stage robust unit commitment optimization model.

In some embodiments, the processor may solve the updated two-stage robust unit commitment optimization model to obtain an optimal unit scheduling scheme for the current period. The optimal unit scheduling scheme refers to an optimal combination sequence of unit start-stop states, generation outputs, frequency regulation reserve capacities, and transmission-distribution tie-line power that still satisfies the full-process frequency security constraints under the worst-case scenario while minimizing the total operating cost of the transmission and distribution network system.

For further details on the two-stage robust unit commitment optimization model and its solution manner, please refer to the relevant description in Step 120.

In some embodiments of the present disclosure, the system, at predetermined intervals, updates the uncertainty sets based on the real-time meteorological information, refreshes the unit output, the transmission network node load, and the distribution network node load using the real-time measurement data and the correction coefficient, and then solves the updated two-stage robust unit commitment optimization model. Day-ahead forecast errors are progressively corrected, the scheduling scheme is adjusted in real-time in response to intraday fluctuations in renewable energy and loads, frequency security constraints are continuously satisfied, and operating costs remain minimized.

In some embodiments of the present disclosure, by incorporating constraints such as power balance, network transmission, unit operation, and frequency regulation capability, a complete feasible region for the MISOCP model is constructed. This ensures that the scheduling scheme complies with the physical operating limits of the transmission and distribution network, provides a computable and implementable mathematical foundation for the two-stage robust unit commitment optimization model, and enhances the feasibility and accuracy of the scheduling scheme.

In some embodiments, the processor may construct the full-process frequency security constraints by establishing limiting conditions for each stage of the full frequency response process—the inertia response, the primary frequency regulation, and the secondary frequency regulation—and incorporating these limiting conditions into the two-stage robust unit commitment optimization model for the transmission and distribution network.

In some embodiments, for the transmission network side, the processor may generate a first frequency regulation command based on the optimal unit scheduling scheme and transmit the first frequency regulation command to the thermal power units. Based on the first frequency regulation command, the thermal power units control the opening degree of the high-pressure control valve in a steam turbine governor system to adjust a steam flow entering the turbine, thereby regulating the active power output of the thermal power units. Additionally, based on the optimal unit scheduling scheme, a second frequency regulation command is generated and transmitted to the wind power units. Based on the second frequency regulation command, the wind power units control a pitch angle of at least one wind turbine blade to change a wind-facing area of the at least one wind turbine blade, thereby regulating the active power output of the wind power units.

The first frequency regulation command refers to a frequency regulation control signal used to regulate the active power out of thermal power units. The first frequency regulation command may include the opening degree of the high-pressure control valve in the steam turbine governor system.

In some embodiments, based on the active power output of the thermal power units specified in the optimal unit scheduling scheme, the processor may query a second preset table to obtain the opening degree of the high-pressure control valve in the steam turbine governor system. The value of the opening degree is then converted into a standard current or digital signal to generate the first frequency regulation command, which is subsequently sent to the steam turbine governor system of the thermal power units. The second preset table may define a relationship between the active power output of the thermal power units and the opening degree of the high-pressure control valve. In some embodiments, the second preset table may be established by technical personnel based on experience.

The high-pressure control valve refers to a valve located at a steam inlet of a high-pressure cylinder of the steam turbine.

In some embodiments, the processor controls the steam flow entering the turbine by adjusting the opening degree of the high-pressure control valve, which is a key actuating component for regulating unit output.

The steam turbine governor system refers to a control system configured to adjust the steam flow into the turbine to control the unit's rotational speed or active power.

It may be understood that the steam turbine governor system can automatically adjust the opening degree of the high-pressure control valve by sensing grid frequency or power deviations, thereby changing the steam flow and achieving rapid regulation of the generator's output power.

In some embodiments, the steam turbine governor system includes a controller, a speed sensing mechanism, an amplification and transmission mechanism, an actuator, and the high-pressure control valve.

The controller refers to a device that compares speed information and opening information and outputs control commands.

In some embodiments, the controller is configured to receive rotational speed information collected by the speed sensing mechanism and the opening information of the high-pressure control valve, and to send electrical signals to the amplification and transmission mechanism.

The speed sensing mechanism refers to a device configured to measure the rotational speed of the steam turbine and generate corresponding signals.

The speed sensing mechanism may include a speed sensor, such as a magnetic reluctance speed probe and a Hall sensor.

In some embodiments, the speed sensing mechanism is configured to measure a rotational speed of the steam turbine's rotor in real time and convert the rotational speed into information such as the rotational speed information and the opening information of the high-pressure control valve.

The amplification and transmission mechanism refers to a device configured to amplify weak signals to drive the actuator.

The weak signals may include displacement, minor oil pressure changes, or milliampere-level currents. For example, the amplification and transmission mechanism may be an electro-hydraulic servo valve.

In some embodiments, the amplification and transmission mechanism is configured to amplify the weak signals sent by the speed sensing mechanism, providing sufficient energy to actuate the valve's actuator. The electro-hydraulic servo valve controls a flow rate and a pressure of hydraulic oil based on an electrical command and typically features a nozzle-flapper or jet-pipe structure.

The actuator refers to a device configured to directly drive the high-pressure control valve to change the opening degree. For example, the actuator may be a high-pressure oil servo motor. In some embodiments, the actuator is configured to receive the amplified control signal and directly drive the steam inlet valve of the steam turbine, thereby altering the steam flow.

In some embodiments, the steam turbine governor system may regulate the active power of the thermal power unit through various manners.

For example, after the steam turbine governor system of the thermal power unit receives the first frequency regulation command, the controller determines a required opening degree of the high-pressure control valve based on a valve control command and the current opening degree of the high-pressure control valve. The controller then converts the required opening degree into a servo current signal and sends the servo current signal to the amplification and transmission mechanism. The amplification and transmission mechanism receives the servo current signal and converts the servo current signal into changes in a flow direction and the pressure of the hydraulic oil, directing a high-pressure fire-resistant fluid to an opening chamber or a closing chamber of a high-pressure oil servo motor cylinder. The high-pressure oil pushes a piston against a spring force, and via a piston rod, directly drives a valve spool of the high-pressure control valve to move up or down. Consequently, a flow-through area of a valve port of the high-pressure control valve port increases or decreases, leading to corresponding changes in the flow rate of the steam flow. This adjusts the mechanical torque of the steam turbine's rotor, and surplus mechanical energy is converted into electrical output by a synchronous generator, thereby achieving active power regulation of the thermal power unit.

The second frequency regulation command refers to a control signal used to adjust the power output of wind power units, including the pitch angle of at least one wind turbine blade.

In some embodiments, based on the active power output of the wind power units specified in the optimal unit scheduling scheme, the processor may query a third preset table to obtain a required pitch angle of the wind turbine blades. The required pitch angle is then converted into a command signal to form the second frequency regulation command, which is subsequently transmitted to the wind power units. The third preset table may define a relationship between the active power output of wind power units and the pitch angle of wind turbine blades. In some embodiments, the third preset table may be established by technical personnel based on experience.

The wind turbine blades refer to aerodynamic components in wind power generator units responsible for capturing wind energy.

In some embodiments, the processor may regulate the active power of wind power units through various manners.

For example, upon receiving the second frequency regulation command, the wind power unit adjusts the pitch angle of the wind turbine blades according to the second frequency regulation command, and controls a speed, a direction, and a pitch adjustment mechanism of at least one wind turbine blade's drive motor to change the pitch angle of the blades, thereby altering a relative position between the wind turbine blades and an incoming wind direction. Consequently, an effective wind-facing area of the blades is adjusted, and the active power regulation of the wind power unit is achieved.

The pitch adjustment mechanism refers to an actuator for adjusting the pitch angle of the wind turbine blades.

For example, the pitch adjustment mechanism includes a pitch bearing, a pitch reducer, and an output pinion.

In some embodiments, one end of the pitch adjustment mechanism is connected to a motor, and the other end is connected to the wind turbine blades.

It may be understood that when the pitch angle decreases (i.e., the blades tend toward feathering), the wind-facing area is reduced, the captured wind energy decreases, and thus the active power output of the wind power unit is lowered. Conversely, the active power output of the wind power unit increases.

In some embodiments, before sending the first and second frequency regulation commands, the processor may determine a power deviation of the optimal unit scheduling scheme based on forecast measurement data and the real-time measurement data, and then adjust the first and second frequency regulation commands based on the power deviation.

The forecast measurement data refers to predicted data used when generating the optimal unit scheduling scheme.

In some embodiments, the processor may read the predicted data used by the system at the time of generating the optimal unit scheduling scheme and designate the predicted data as the forecast measurement data.

The real-time measurement data refers to measured data reflecting the actual system state.

In some embodiments, the processor may obtain the real-time measurement data by measuring current system data before executing the commands. For further details on the real-time measurement data, please refer to the relevant section below.

The power deviation refers to a difference between the forecast measurement data and the real-time measurement data at the same time point, including deviations for each parameter in the measurement data.

In some embodiments, the processor may calculate the deviation by determining a difference between the forecast measurement data and the real-time measurement data for each parameter, and designate the difference as the power deviation.

In some embodiments, based on the power deviation, the processor may determine a first compensation amount and a second compensation amount through cluster analysis. Using the first compensation amount, the processor compensates the active power output of thermal power units in the optimal unit scheduling scheme and, based on the compensated active power output of thermal power units, determines an adjusted first frequency regulation command by querying a fourth preset table. Similarly, using the second compensation amount, the processor compensates the active power output of wind power units in the optimal unit scheduling scheme and, based on the compensated active power output of wind power units, determines an adjusted second frequency regulation command by querying a fifth preset table. The fourth preset table may define a relationship between the active power output of thermal power units and the first frequency regulation command, and the fifth preset table may define a relationship between the active power output of wind power units and the second frequency regulation command. In some embodiments, the fourth and fifth preset tables may be predefined by technical personnel based on experience.

For example, the technical personnel may construct the fourth preset table based on different historical first frequency regulation commands corresponding to different output ranges of thermal power units, and construct the fifth preset table based on different historical second frequency regulation commands corresponding to different output ranges of wind power units.

In the cluster analysis, objects to be clustered are cluster vectors and a target vector. The cluster vectors consist of multiple historical power deviations, with labels indicating the difference between the measured active power output of units after applying historical optimal unit scheduling schemes corresponding to these historical power deviations and expected active power output in the historical optimal unit scheduling schemes. The target vector includes the forecast measurement data and current real-time measurement data. In some embodiments, the processor clusters the objects to be clustered to obtain multiple clusters, designates a cluster containing the target vector as the target cluster, and takes an average of the labels corresponding to all cluster vectors within the target cluster as the first and second compensation amounts corresponding to the target vector.

The first compensation amount refers to an active power output compensation amount for thermal power units.

The second compensation amount refers to an active power output compensation amount for wind power units.

In some embodiments of the present disclosure, the system performs a second correction based on measured data within a millisecond-level window before command execution, dynamically evaluates the power deviation by combining the forecast measurement data and the real-time measurement data, and adjusts the first and second frequency regulation commands accordingly. This approach effectively compensates for dispatch deviations caused by forecast errors or system state changes, improves command execution accuracy, eliminates control errors arising from communication and computational delays, and enhances the matching precision of dispatch commands to the real-time system state.

In some embodiments of the present disclosure, by converting the optimized optimal unit scheduling scheme into physical actions of steam turbine valves and wind turbine controllers, the system achieves concrete implementation from a mathematical model to a physical device execution layer of the transmission network, ensuring the physical controllability of the frequency response of the transmission and distribution network.

In some embodiments, for the distribution network side, the processor may generate a start-stop command based on the optimal unit scheduling scheme and transmit the start-stop command to the thermal power units and photovoltaic units. The generator units then control the start-stop states of the distributed generator units and the photovoltaic units based on the start-stop command.

The start-stop command refers to a control signal used to initiate or halt the operation of generator units.

In some embodiments, the processor may determine the start-stop states of the units from the optimal unit scheduling scheme, identify the start-stop state of each thermal power unit and distributed energy resource based on the optimal unit scheduling scheme, and generate the corresponding start-stop command.

In some embodiments, the processor may control the actuators of the distributed generator units and photovoltaic units by sending the start-stop command to the controllers of the generator units, thereby switching the start-stop states of the generator units.

In some embodiments of the present disclosure, the system directly encodes the start-stop state into the start-stop command and sends the start-stop command to the actuators, causing the units to start up or shut down immediately. The generation of the start-stop command and the execution of control actions are seamlessly connected, eliminating the need for manual confirmation, thereby compressing start-stop latency of distributed resources on the distribution network side and correspondingly improves the speed of coordinated response.

In some embodiments of the present disclosure, by constructing the full-process frequency security constraints and incorporating the inertia response, the primary frequency regulation, and the secondary frequency regulation into a unified unit commitment optimization framework, and by establishing the two-stage robust unit commitment optimization model with the min-max-min structure, the problem of power imbalance and congestion caused by the independent operation of transmission and distribution networks in traditional dispatch is effectively addressed. Through the participation of low-cost flexible resources such as wind power units and distributed energy resources in frequency regulation, the start-stop frequency and frequency regulation reserve costs of thermal power units are significantly reduced, enhancing the overall economic efficiency of the system. Meanwhile, the uncertainty sets in the interval form are used to characterize wind and photovoltaic power fluctuations, and the column-and-constraint generation (C&CG) algorithm together with the strong duality theory transforms the model into a mixed-integer second-order cone programming (MISOCP) model that can be efficiently solved. The method ensures that the scheduling scheme maintains full-process frequency security even under the worst-case scenario of wind power output and photovoltaic power output, greatly enhancing the robustness and stability of the scheduling scheme. Compared to traditional methods relying solely on thermal power for frequency regulation, the present disclosure fully exploits the coordinated frequency regulation potential of the transmission and distribution network, effectively alleviates the operational pressure on thermal power units, promotes the integration of renewable energy, and achieves the organic unity of secure, stable, and economical operation of transmission and distribution networks under uncertain conditions.

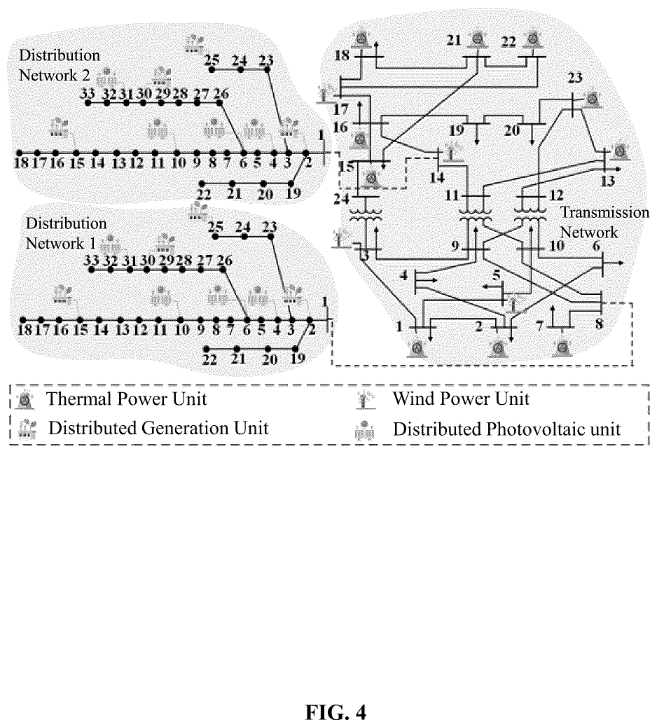

FIG. 4 is a schematic diagram illustrating a test case system according to some embodiments of the present disclosure.

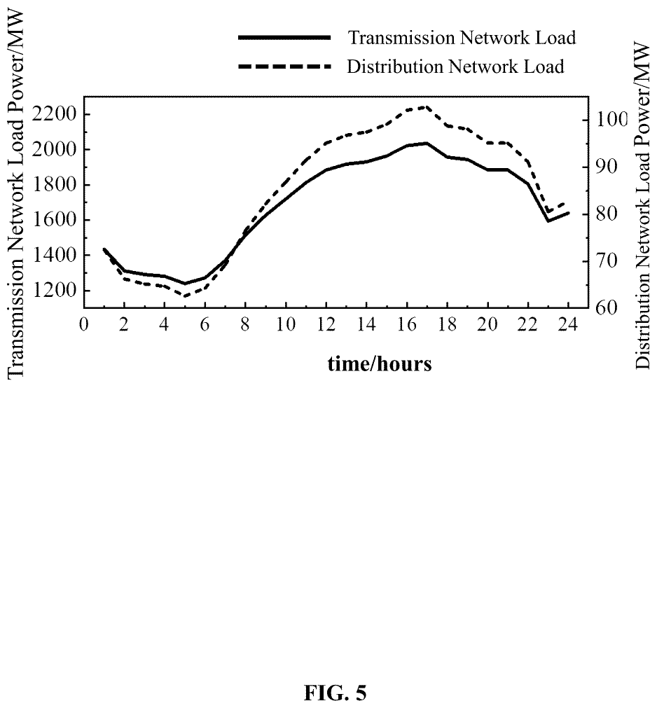

FIG. 5 is a schematic diagram illustrating system load forecasting according to some embodiments of the present disclosure.

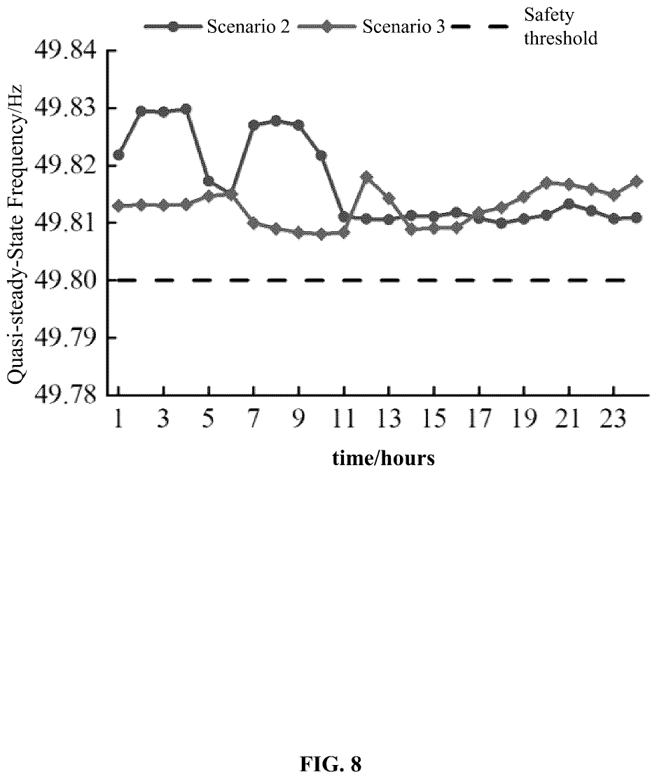

FIG. 8 is a comparison chart illustrating quasi-steady-state frequencies for Scenario 2 and Scenario 3 according to some embodiments of the present disclosure.

The following describes, in conjunction with specific examples, the feasibility verification of the method of robust unit scheduling for a transmission and distribution network based on the full frequency response process proposed in the embodiments of the present disclosure. The verification is performed using a transmission and distribution network formed by coupling an IEEE 24-node transmission system with two IEEE 33-node distribution systems. The coupled transmission and distribution network system is shown in FIG. 4, and its forecast load is shown in FIG. 5.

This embodiment sets up three comparative scenarios for analysis of the test case system:
Scenario 1: Frequency security constraints are not considered, and unit reserve capacity is added to assist system primary frequency regulation.
Scenario 2: Based on Scenario 1, the full-process frequency security constraints are considered, with frequency support provided by thermal power units and wind power units.
Scenario 3: Based on Scenario 2, the participation of distributed energy resources in the full-process frequency regulation of the system is considered.

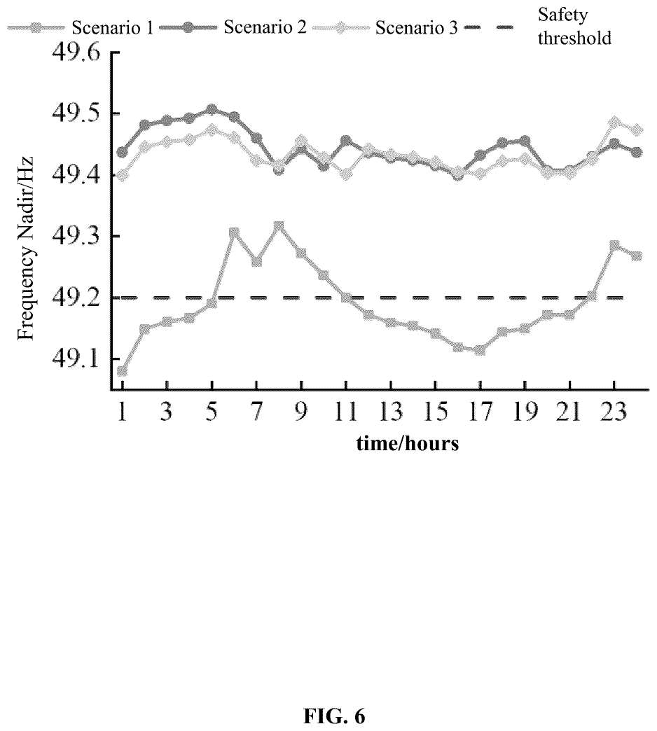

FIG. 6 is a comparison chart illustrating frequency nadirs for Scenario 1, Scenario 2, and Scenario 3 according to some embodiments of the present disclosure.

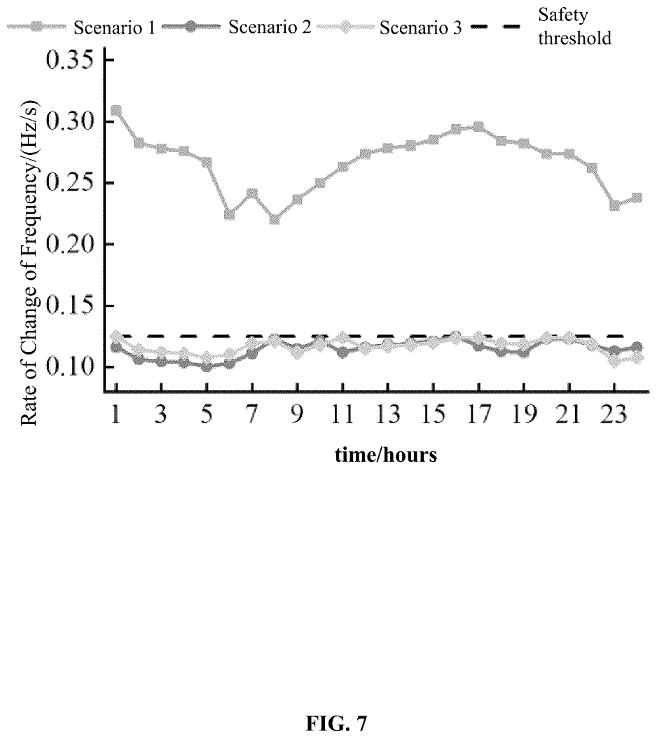

FIG. 7 is a comparison chart illustrating system Rates of Change of Frequency (RoCoF) for Scenario 1, Scenario 2, and Scenario 3 according to some embodiments of the present disclosure.

Comparisons of the frequency nadir f_{nadir} and the system RoCoF among Scenario 1, Scenario 2, and Scenario 3 are shown in FIG. 6 and FIG. 7, respectively.

As shown in FIG. 6 and FIG. 7, in Scenario 1, the frequency nadirs f_{nadir} at time periods 1-5 and 12-24 both exceed a safety limit of 49.2 Hz, and the system RoCoF at all time periods is greater than a maximum allowable RoCoF value of 0.125 Hz/s. This is because Scenario 1 does not consider frequency security constraints and only adds primary frequency regulation constraints to maintain basic system frequency stability. In this case, whether the system primary frequency regulation reserve capacity is sufficient cannot be guaranteed, and frequency can only be adjusted to a certain extent through basic reserve capacity of online units, which cannot ensure system frequency stability under large disturbances. When the frequency security constraints are considered in Scenario 2 and Scenario 3, both the frequency nadirs f_{nadir} and the system RoCoF at all time periods remain within preset safety thresholds. Moreover, the system frequency regulation performance in Scenario 3 is close to that in Scenario 2. The above analysis demonstrates the significant role of the method in enhancing system frequency security.

FIG. 8 is a comparison chart illustrating quasi-steady-state frequencies for Scenario 2 and Scenario 3 according to some embodiments of the present disclosure.

As shown in FIG. 8, after considering the secondary frequency regulation security constraints, the quasi-steady-state frequencies corresponding to both Scenario 2 and Scenario 3 are greater than a preset quasi-steady-state frequency safety threshold. The secondary frequency regulation reserve capacity dispatched by the system at each time period is closely related to a magnitude of the quasi-steady-state frequency, such that the smaller the quasi-steady-state frequency is, the larger the secondary frequency regulation reserve capacity issued by the system is. Compared with Scenario 2, quasi-steady-state frequency fluctuations corresponding to Scenario 3 are relatively smoother, demonstrating that the present disclosure has superiority in ensuring safe and stable operation of the system. As shown in Table 1, a comparison of operating costs under respective scenarios is provided:

TABLE 1
Cost Comparison for Scenario 1, Scenario 2, and Scenario 3

| | | | Frequency | |
|---|---|---|---|---|
| | | Generation | Regulation | Start-stop |
| | Total Cost | Cost | Reserve Cost | Cost |
| Scenario | (×10⁵ CNY) | (×10⁵ CNY) | (×10⁵ CNY) | (×10⁴ CNY) |
| 1 | 7.87 | 5.95 | 1.83 | 0.93 |
| 2 | 8.62 | 7.01 | 1.36 | 2.55 |
| 3 | 8.46 | 7.05 | 1.20 | 2.05 |

In Table 1, since frequency security constraints are not considered in Scenario 1, capacity of low-cost units in Scenario 1 can satisfy system load demand and frequency regulation demand. After frequency security constraints are considered in Scenario 2 and Scenario 3, part of the low-cost units in the system are used for frequency regulation, and high-cost units are required to be dispatched to participate in power generation. Therefore, compared with Scenario 1, generation costs in Scenario 2 and Scenario 3 increase by 1.06×10⁵ CNY and 1.10×10⁵ CNY, respectively. Since wind power units with favorable economics and distributed energy resources are respectively considered, on the basis of the former scenario, to substitute part of thermal power units to participate in system frequency regulation in Scenario 2 and Scenario 3, frequency regulation reserve costs in Scenario 2 are reduced by 4.70×10⁴ CNY compared with Scenario 1, and frequency regulation reserve costs in Scenario 3 are reduced by 1.60×10⁴ CNY compared with Scenario 2. At this time, because participation of distributed photovoltaic generation in frequency regulation reduces its power generation capacity, thermal power units and conventional distributed generating units need to output additional power to compensate for system power imbalance. Therefore, compared with Scenario 2, generation costs in Scenario 3 increase by 4×10³ CNY, while start-stop costs are reduced by 500 CNY. The above analysis demonstrates that the method provided in the present disclosure can improve system economic efficiency.

In summary, through the design of full-process constraints for inertia response, primary frequency regulation, and secondary frequency regulation, the present disclosure can effectively reduce the magnitude of system frequency fluctuations after power disturbances, ensuring frequency deviations remain within safe limits and preventing frequency instability. The participation of renewable energy units and distributed energy resources shares the frequency regulation tasks of thermal power units, reducing the start-stop frequency and operational burden of thermal units. By considering the joint participation of thermal power units, renewable energy units, and distributed energy resources in frequency support, the advantages of various frequency regulation resources are fully exploited, enhancing the overall frequency regulation capability of the system.

The present disclosure reasonably models and optimizes the output uncertainty of renewable energy units, thereby reducing the risk of excessive frequency fluctuations caused by the integration of renewable energy sources and ensuring stable system operation. Through robust optimization, which analyzes and handles worst-case scenarios, the feasibility and safety of the scheduling scheme under extreme conditions are guaranteed. Through the robust unit commitment optimization model, excessive conservatism of optimization results can be reduced as much as possible while extreme conditions are taken into account, thereby improving economic efficiency of system operation. By optimizing the start-stop states of thermal power units, unnecessary start-stop operation costs are reduced. Simultaneously, when generation and frequency regulation reserve allocation are optimized, primary and secondary frequency regulation reserve costs are reduced, so that overall system operating costs are minimized. Under the premise of satisfying frequency security constraints, the optimized configuration of generation and reserve resources ensures both frequency stability and economic operation.

The column-and-constraint generation (C&CG) algorithm improves solving efficiency significantly by progressively introducing the most relevant constraints, avoiding the need to solve a complex full-space problem directly. Transforming the two-stage robust unit commitment optimization model with the min-max-min structure using the strong duality theory and iteratively introducing subproblem results into the master problem yields more accurate optimization results, with the upper and lower bounds of the objective function ultimately converging. Solving for the unit scheduling scheme under the worst-case scenario of wind power output and photovoltaic power output ensures the stability and feasibility of dispatch results under extreme operating conditions.

Therefore, the method of the present disclosure effectively enhances the frequency regulation capability of transmission and distribution networks, reduces operating costs, improves the robustness and efficiency of scheduling schemes, and ensures the secure, stable, and economical operation of transmission and distribution networks under conditions of uncertainty in the output of renewable energy sources such as wind and photovoltaic power.

Those skilled in the art may understand that the accompanying drawings are merely schematic diagrams of preferred embodiments, and the above embodiment numbers are only used for description and do not represent superiority or inferiority of the embodiments.

The basic concepts have been described above. Obviously, for those skilled in the art, the detailed disclosure above is merely illustrative and does not constitute a limitation on the present disclosure. Although not explicitly stated, those skilled in the art may make various modifications, improvements, and corrections to the present disclosure. Such modifications, improvements, and corrections are suggested within the present disclosure and thus remain within the spirit and scope of the exemplary embodiments of the present disclosure.

Meanwhile, the present disclosure uses specific terms to describe the embodiments herein. Terms such as “one embodiment,” “an embodiment,” and/or “some embodiments” mean that a certain feature, structure, or characteristic related to at least one embodiment of the present disclosure. Therefore, it is emphasized and noted that the terms “an embodiment,” “one embodiment,” or “an alternative embodiment” mentioned two or more times at different locations in the present disclosure do not necessarily refer to the same embodiment. Furthermore, certain features, structures, or characteristics in one or more embodiments of the present disclosure may be appropriately combined.

Furthermore, unless explicitly stated in the claims, the order of processing elements and sequences, the use of numbers or letters, or the use of other names in the present disclosure is not intended to limit the order of the processes and methods described herein. Although the foregoing disclosure discusses some currently considered useful inventive embodiments through various examples, it should be understood that such details are for illustrative purposes only, and the appended claims are not limited to the disclosed embodiments. On the contrary, the claims are intended to cover all modifications and equivalent combinations that conform to the essence and scope of the embodiments of the present disclosure. For example, although the system components described above may be implemented via hardware devices, they may also be realized solely through software solutions, such as installing the described system on existing servers or mobile devices.

Similarly, it should be noted that to simplify the presentation of the present disclosure and thereby aid in understanding one or more inventive embodiments, in the descriptions of the embodiments of the present disclosure above, various features may sometimes be grouped into a single embodiment, figure, or description thereof. However, this disclosure manner does not imply that the subject matter of the present disclosure requires more features than those mentioned in the claims. In fact, the features of an embodiment are fewer than all the features of a single embodiment disclosed above.

In some embodiments, numbers describing quantities or attributes are used. It should be understood that such numbers used in the description of the embodiments may, in some examples, be modified by the terms “approximately,” “about,” or “substantially.” Unless otherwise specified, “approximately,” “about,” or “substantially” indicates that the stated number allows for a variation of ±20%. Accordingly, in some embodiments, the numerical parameters used in the specification and claims are approximations, which may vary depending on the characteristics required by individual embodiments. In some embodiments, numerical parameters should consider the specified number of significant digits and adopt the method of general digit retention. Although the numerical ranges and parameters used to confirm their breadth in some embodiments of the present disclosure are approximations, in specific embodiments, such numerical values are set as accurately as possible within the feasible range.

For each patent, patent application, patent application publication, and other material, such as articles, books, specifications, publications, documents, etc., cited in the present disclosure, the entire content thereof is hereby incorporated by reference into the present disclosure. Excluded are application history documents that are inconsistent or conflict with the content of the present disclosure, and documents that limit the broadest scope of the claims of the present disclosure (whether currently or subsequently appended to the present disclosure). It should be noted that if the description, definition, and/or use of terms in the supplementary materials of the present disclosure are inconsistent or conflict with those in the present disclosure, the description, definition, and/or use of terms in the present disclosure shall prevail.

Finally, it should be understood that the embodiments described in the present disclosure are merely illustrative of the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to those explicitly introduced and described herein.

What is claimed is:

1. A method of robust unit scheduling for a transmission and distribution network based on a full frequency response process, comprising:
establishing a framework structure of the transmission and distribution network, taking into account start-stop states of thermal power units, and analyzing a dynamic frequency response process in which centralized renewable energy units and distributed energy resources jointly provide frequency support together with the thermal power units, wherein full-process frequency security constraints are constructed for three stages including inertia response, primary frequency regulation, and secondary frequency regulation;
wherein the full-process frequency security constraints include primary frequency regulation security constraints and secondary frequency regulation security constraints;
the primary frequency regulation security constraints include:
a Rate of Change of Frequency (RoCoF) constraint, wherein when a power deficit begins to occur in a transmission and distribution network system, a system frequency deviation Δfₜ≈0, at which time no units in the transmission and distribution network system have taken action, and a system rate of change of frequency is required to satisfy a maximum allowable requirement, wherein a system inertia time constant is jointly determined by inertia time constants of all dispatchable frequency regulation resources within the transmission and distribution network system, and the RoCoF constraint is expressed as:
$$RoCoF = \frac{\partial Δ {f}_{t}}{\partial t} = \frac{\vert Δ {P}_{L , t} \vert \cdot {f}_{0}}{2 {H}_{g , t}} \leq RoCo {F}^{max}$$
wherein RoCoF denotes the system rate of change of frequency; Δfₜ denotes a system frequency deviation after an occurrence of the power deficit at a time t; f₀ denotes a system nominal frequency; ΔP_{L,t} denotes a system power deficit; H_{g,t} denotes a system inertia time constant at the time t; RoCoF^{max} denotes the maximum allowable requirement of the system rate of change of frequency;
a frequency nadir constraint, wherein the inertia response and the primary frequency regulation jointly act to cause a system frequency to decrease to a frequency nadir, during which each unit is required to reserve a primary frequency regulation reserve capacity to participate in the primary frequency regulation so as to prevent the system frequency deviation after the occurrence of the power deficit at the time t from exceeding a given safety threshold, and the system frequency is expressed as:
$$\vert Δ {f}_{nadir , t} \vert = \frac{2 {R}_{t}^{P} {H}_{g , t}}{{{T}_{d}^{P} ( D {P}_{t}^{D} )}^{2}} log ( \frac{2 {R}_{t}^{P} {H}_{g , t}}{{T}_{d}^{P} D {P}_{t}^{D} Δ {P}_{L , t}^{′} + 2 {R}_{t}^{P} {H}_{g , t}} ) + \frac{Δ {P}_{L , t}^{′}}{D {P}_{t}^{D}} + Δ {f}_{D B} \leq Δ {f}^{max}$$
wherein |Δf_{nadir,t}| denotes the system frequency deviation at the time t;
$${R}_{t}^{P}$$
denotes a sum of primary frequency regulation reserve capacities of units in the transmission and distribution network system at the time t;
$${T}_{d}^{P}$$
denotes a response time of the primary frequency regulation of the transmission and distribution network system; D denotes a load damping coefficient;
$${P}_{t}^{D}$$
denotes a system load;
$$Δ {P}_{L , t}^{′}$$
denotes power deficit of the transmission and distribution network system when entering the inertia response at the time t; Δf_{DB} denotes a frequency dead band; Δf^{max} denotes the given safety threshold;
a quasi-steady-state frequency constraint, wherein when the primary frequency regulation reserve capacities of the units in the transmission and distribution network system are fully released, the system frequency is maintained at a quasi-steady-state frequency, and a quasi-steady-state frequency deviation at the time t is required to be controlled within a maximum allowable range
$$Δ {f}_{q s s}^{max}$$
of the transmission and distribution network system, and the quasi-steady-state frequency constraint is expressed as:
$$\vert Δ {f}_{qss , t} \vert = \frac{Δ {P}_{L , t} - {R}_{t}^{P}}{D {P}_{t}^{D}} \leq Δ {f}_{q s s}^{max} ;$$
wherein |Δf_{qss,t}| denotes the quasi-steady-state frequency deviation at the time t; the secondary frequency regulation security constraints include:
a secondary frequency regulation reserve capacity constraint, wherein, in order to restore the system frequency to a nominal frequency value by an end of the secondary frequency regulation, a sum of secondary frequency regulation reserve capacities and the primary frequency regulation reserve capacities of the units in the transmission and distribution network system is not less than the system power deficit, and the secondary frequency regulation reserve capacity constraint is expressed as:
$${R}_{t}^{P} + {R}_{t}^{S} \geq Δ {P}_{L , t} ;$$
wherein
$${R}_{t}^{S}$$
denotes a sum of the secondary frequency regulation reserve capacities of the units in the transmission and distribution network system at the time t;
a secondary frequency regulation frequency deviation accumulation constraint, wherein an accumulated amount of secondary frequency regulation frequency deviation in the transmission and distribution network system is required to be maintained within a predetermined range so as to avoid excessive deviation of the system frequency from the nominal frequency value at a beginning of the secondary frequency regulation, and the secondary frequency regulation frequency deviation accumulation constraint is expressed as:
$$S F {R}^{min} \leq ( Δ {P}_{L , t} - {R}_{t}^{P} - {R}_{t}^{S} ) \frac{{t}^{s} - 2 {σ}_{2}}{20 {σ}_{1}} \leq S F {R}^{max}$$
wherein t^{s} denotes an ending time of the accumulated secondary frequency regulation frequency deviation in the transmission and distribution network system; σ₁ denotes a system frequency deviation coefficient; σ₂ denotes an integral control parameter; SFR^{max} and SFR^{min} denote an upper limit and a lower limit of the accumulated secondary frequency regulation frequency deviation in the transmission and distribution network system, respectively;
constructing an uncertainty set of wind power output and an uncertainty set of photovoltaic power output in an interval form by considering uncertainty of wind power output and uncertainty of photovoltaic power output, establishing a two-stage robust unit commitment optimization model of the transmission and distribution network considering the full-process frequency response with a min-max-min structure, and minimizing a sum of start-stop costs, generation costs, primary frequency regulation reserve costs, and secondary frequency regulation reserve costs as an objective; and
converting, by using a column-and-constraint generation algorithm and a strong duality theory, the two-stage robust unit commitment optimization model of the transmission and distribution network into a mixed-integer second-order cone programming model, and iteratively solving the mixed-integer second-order cone programming model until an upper bound and a lower bound of an objective function converge, thereby obtaining an optimal unit scheduling scheme under a worst-case scenario of the wind power output and the photovoltaic power output.

2. The method of claim 1, wherein in the framework structure of the transmission and distribution network, dispatchable frequency regulation resources of a transmission network include the thermal power units and wind power units considering unit start-stop, dispatchable frequency regulation resources of an active distribution network include distributed generator units and photovoltaic units, and power between the transmission network and the distribution network is balanced through bidirectional power transmission so as to balance an overall load of the transmission and distribution network system and satisfy a frequency security requirement of the transmission and distribution network system.

3. The method of claim 1, wherein when the power deficit occurs in the transmission and distribution network system, the system frequency exhibits a downward trend, the transmission and distribution network system enters the dynamic frequency response process, and the dynamic frequency response process includes:
the inertia response, wherein kinetic energy is provided by inertia within the transmission and distribution network system to regulate the system frequency, generator units do not operate, and the system rate of change of frequency (RoCoF) of the transmission and distribution network system reaches a maximum value;
the primary frequency regulation, wherein the generator units in the transmission and distribution network system start to change mechanical power, the inertia response and the primary frequency regulation jointly regulate the power deficit, the thermal power units in the transmission network regulate generation power and a frequency regulation power based on predetermined unit start-stop decisions, wind power units in the transmission network and distributed generator units and photovoltaic units in an active distribution network directly allocate the wind power output, the photovoltaic power output, and the frequency regulation resources, until unit power output equals a disturbance, and the system frequency drops to a frequency nadir f_{nadir}; and
the secondary frequency regulation, wherein, when the frequency stabilizes at the quasi-steady-state frequency f_{qss}, the primary frequency regulation ends, and the transmission and distribution network system continues to perform the secondary frequency regulation until the system frequency is restored to the nominal frequency value.

4. The method of claim 1, wherein the uncertainty set of wind power output and the uncertainty set of photovoltaic power output are expressed as:
$$U = [ {Un}^{W} , {Un}^{P} ] = \{ \begin{matrix}{P}_{w , t}^{un} = {P}_{w , t}^{max} - {α}_{w , t}^{-} Δ {P}_{w , t} \\ {P}_{p , t}^{un} = {P}_{p , t}^{max} - {α}_{p , t}^{-} Δ {P}_{p , t} \\ {\sum }_{t ∈ T} {α}_{w , t}^{-} \leq {Γ}_{w} , {\sum }_{t ∈ T} {α}_{p , t}^{-} \leq {Γ}_{p} \\ {α}_{w , t}^{-} \leq 1 , {α}_{p , t}^{-} \leq 1 \\ {α}_{w , t}^{-} , {α}_{p , t}^{-} ∈ \{ 0 , 1 \}\end{matrix}$$
wherein U denotes a set including the uncertainty set of wind power output and the uncertainty set of photovoltaic power output; Un^{W} and Un^{P} denote the uncertainty set of wind power output and the uncertainty set of photovoltaic power output, respectively;
$${P}_{w , t}^{u n} and {P}_{p , t}^{un}$$
denote an uncertainty-adjusted power of the wind power output and an uncertainty-adjusted power of the photovoltaic power output, respectively;
$${P}_{w , t}^{max} and {P}_{p , t}^{max}$$
denote a predicted wind power output and a predicted photovoltaic power output, respectively; ΔP_{w,t} and ΔP_{p,t} denote a maximum allowable fluctuation range of the wind power output and a maximum allowable fluctuation range of the photovoltaic power output, respectively;
$${α}_{w , t}^{-} and {α}_{p , t}^{-}$$
respectively denote binary variables indicating, at the time t, whether the wind power output and the photovoltaic power output reach an interval boundary; Γ_{w} and Γₚ respectively denote an introduced wind uncertainty level and an introduced photovoltaic uncertainty level, representing a total count of time periods at which the wind power output and the photovoltaic power output reach the interval boundary; T denotes a total count of scheduling time periods.

5. The method of claim 1, wherein an objective function of the two-stage robust unit commitment optimization model of the transmission and distribution network is expressed as:
$$\{ \begin{matrix}min {F}_{1} + max min ( {F}_{2} + {F}_{3} ) \\ {F}_{1} = {\sum }_{i ∈ T G} {\sum }_{C ∈ T} ( {C}_{i}^{s u} s {u}_{i , t} + {C}_{i}^{s v} s {v}_{i , t} ) \\ {F}_{2} = {\sum }_{l ∈ T G} {\sum }_{C ∈ T} {C}_{i} {P}_{i , t} + {\sum }_{j ∈ D G} {\sum }_{t ∈ T} {C}_{j} {P}_{j , t} \\ {F}_{3} = {\sum }_{i ∈ TG} {\sum }_{C ∈ T} {C}_{i}^{P} {R}_{i , t}^{P} + {\sum }_{w ∈ T W} {\sum }_{C ∈ T} {C}_{w}^{P} {R}_{w , t}^{P} + \\ {\sum }_{j ∈ D G} {\sum }_{t ∈ T} {C}_{j}^{P} {R}_{j , t}^{P} + {\sum }_{p ∈ D P} {\sum }_{t ∈ T} {C}_{p}^{P} {R}_{p , t}^{P} + \\ {\sum }_{i ∈ TG} {\sum }_{t ∈ T} {C}_{i}^{S} {R}_{i , t}^{S} + {\sum }_{w ∈ T W} {\sum }_{t ∈ T} {C}_{w}^{S} {R}_{w , t}^{S} + \\ {\sum }_{j ∈ D G} {\sum }_{t ∈ T} {C}_{j}^{S} {R}_{j , t}^{S} + {\sum }_{p ∈ D P} {\sum }_{t ∈ T} {C}_{p}^{S} {R}_{p , t}^{S}\end{matrix}$$
wherein F₁ denotes a sum of start-stop costs of the thermal power units; F₂ denotes a sum of generation costs of the thermal power units and distributed generator units; F₃ denotes a sum of primary frequency regulation reserve costs and secondary frequency regulation reserve costs; T denotes a total count of scheduling time periods;
$${C}_{i}^{s u} and {C}_{i}^{s v}$$
denote a start-up cost and a shutdown cost of a thermal power unit i, respectively; su_{i,t} and sv_{i,t} denote a start-up state and a shutdown state of the thermal power unit i at the time t, respectively; Cᵢ and Cⱼ denote a generation cost of the thermal power unit i and a generation cost of a distributed generator unit j, respectively; P_{i,t} and P_{j,t} denote an active power output of the thermal power unit i and an active power output of the distributed generator unit j at the time t, respectively;
$${C}_{i}^{P} , {C}_{w}^{P} , {C}_{j}^{P} , and {C}_{p}^{P}$$
denote a primary frequency regulation reserve cost of the thermal power unit i, a primary frequency regulation reserve cost of a wind power unit w, a primary frequency regulation reserve cost of the distributed generator unit j, and a primary frequency regulation reserve cost of a photovoltaic unit p, respectively;
$${C}_{i}^{S} , {C}_{w}^{S} , {C}_{j}^{S} , and {C}_{p}^{S}$$
denote a secondary frequency regulation reserve cost of the thermal power unit i, a secondary frequency regulation reserve cost of the wind power unit w, a secondary frequency regulation reserve cost of the distributed generator unit j, and a secondary frequency regulation reserve cost of the photovoltaic unit p, respectively;
$${R}_{i , t}^{P} , {R}_{w , t}^{P} , {R}_{j , t}^{P} , and {R}_{p , t}^{P}$$
denote a primary frequency regulation reserve capacity of the thermal power unit i, a primary frequency regulation reserve capacity of the wind power unit w, a primary frequency regulation reserve capacity of the distributed generator unit j, and a primary frequency regulation reserve capacity of the photovoltaic unit p at the time t, respectively;
$${R}_{i , t}^{S} , {R}_{w , t}^{S} , {R}_{j , t}^{S} , and {R}_{p , t}^{S}$$
denote a secondary frequency regulation reserve capacity of the thermal power unit i, a secondary frequency regulation reserve capacity of the wind power unit w, a secondary frequency regulation reserve capacity of the distributed generator unit j, and a secondary frequency regulation reserve capacity of the photovoltaic unit p at the time t, respectively; TG, TW, DG, and DP denote a set of thermal power units, a set of wind power units, a set of distributed generator units, and a set of photovoltaic units participating in a frequency regulation process, respectively.

6. The method of claim 5, wherein constraint conditions of the two-stage robust unit commitment optimization model of the transmission and distribution network, in addition to the full-process frequency security constraints, further include:
$${\sum }_{i ∈ a} {P}_{i , t} + {\sum }_{w ∈ a} {P}_{w , t} - {\sum }_{ttan l ∈ a} {P}_{tran l , t} - {\sum }_{e ∈ a} {P}_{e , t}^{T D} = {\sum }_{∀ b ∈ Ω ( : , a )} ( {f}_{b a , t} - {f}_{a b , t} )$$
$$\{ \begin{matrix}{f}_{ab , t} = {B}_{a b} ( {θ}_{a , t} - {θ}_{b , t} ) \\ \vert {f}_{ab , t} \vert \leq {F}_{f l ow , ab}^{max} \\ - π \leq {θ}_{a , t} \leq π \\ {θ}_{r , t} = 0\end{matrix}$$
$$\{ \begin{matrix}{\sum }_{k = t}^{t + {T}_{on , i} - 1} {u}_{i , k} \geq {T}_{on , i} ( {u}_{i , t} - {u}_{i , t - 1} ) \\ {\sum }_{k = t}^{c + {T}_{off , i} - 1} ( 1 - {u}_{i , k} ) \geq {T}_{off , i} ( {u}_{i , t - 1} - {u}_{i , t} )\end{matrix}$$
$$\{ \begin{matrix}{u}_{i , t} + {u}_{i , t - 1} \leq {su}_{i , t} - {sv}_{i , t} \\ {su}_{i , t} + s {v}_{i , t} \leq 1\end{matrix}$$
$$\{ \begin{matrix}{P}_{i , t} + {R}_{i , t}^{P} + {R}_{i , t}^{S} - {P}_{i , t - 1} - {R}_{i , t - 1}^{P} - {R}_{i , t - 1}^{S} \leq {ramp}_{i}^{u} \\ {P}_{i , t} + {R}_{i , t}^{P} + {R}_{i , t}^{S} - {P}_{i , t - 1} - {R}_{i , t - 1}^{P} - {R}_{i , t - 1}^{S} \geq - {ramp}_{i}^{d}\end{matrix}$$
$${u}_{i , t} \cdot {P}_{i}^{min} \leq {P}_{i , t} \leq {u}_{i , t} \cdot {P}_{i}^{max} - {R}_{i , t}^{P} - {R}_{i , t}^{S}$$
$${P}_{w , t}^{min} \leq {P}_{w , t} \leq {P}_{w , t}^{un} - {R}_{w , t}^{P} - {R}_{w , t}^{S}$$
$$0 \leq {R}_{i , t}^{P} + {R}_{i , t}^{S} \leq {u}_{i , t} \cdot {R}_{i}^{max}$$
$$0 \leq {R}_{w , t}^{P} + {R}_{w , t}^{S} \leq {R}_{w , t}^{max}$$
$${R}_{i , t}^{P} \geq 0$$
$${R}_{i , t}^{S} \geq 0$$
$${R}_{w , t}^{P} \geq 0$$
$${R}_{w , t}^{S} \geq 0$$
$$\{ \begin{matrix}{P}_{j , n , t} + {P}_{p , n , t} + {\sum }_{m ∈ {ϕ}_{1} ( : , n )} ( {P}_{mn , t} - {I}_{mn , t}^{2} {r}_{m n} ) + {P}_{e , n , t}^{T D} = {\sum }_{d ∈ {ϕ}_{2} ( n , : )} {P}_{nd , t} + {P}_{d istl , n , t} \\ {Q}_{j , n , t} + {Q}_{p , n , t} + {\sum }_{m ∈ {ϕ}_{1} ( : , n )} ( {Q}_{mn , t} - {I}_{mn , t}^{2} {x}_{m n} ) + {Q}_{e , n , t}^{T D} = {\sum }_{d ∈ {ϕ}_{2} ( n , : )} {Q}_{nd , t} + {Q}_{distl , n , t}\end{matrix}$$
$${U}_{n , t}^{2} = {U}_{m , t}^{2} - 2 ( {r}_{m n} {P}_{m n , t} + {x}_{m n} {Q}_{m n , t} ) + ( {r}_{m n}^{2} + {x}_{m n}^{2} ) {I}_{m n , t}^{2}$$
$${U}_{n}^{min} \leq {U}_{n , t} \leq {U}_{n}^{max}$$
$$‖ \begin{matrix}2 {P}_{mn , t} \\ 2 {Q}_{mn , t} \\ {I}_{mn , t}^{2} - {U}_{m , t}^{2}\end{matrix} ‖ \leq {I}_{mn , t}^{2} + {U}_{m , t}^{2}$$
$${P}_{j}^{min} \leq {P}_{j , t} \leq {P}_{j}^{max} - {R}_{j , t}^{P} - {R}_{j , t}^{S}$$
$${P}_{p , t}^{min} \leq {P}_{p , t} \leq {P}_{p , t}^{un} - {R}_{j , t}^{P} - {R}_{j , t}^{S}$$
$$0 \leq {R}_{j , t}^{P} + {R}_{j , t}^{S} \leq {R}_{j}^{max}$$
$$0 \leq {R}_{p , t}^{P} + {R}_{p , t}^{S} \leq {R}_{p , t}^{max}$$
$${R}_{j , t}^{P} \geq 0$$
$${R}_{j , t}^{S} \geq 0$$
$${R}_{p , t}^{P} \geq 0$$
$${R}_{p , t}^{S} \geq 0$$
$${P}_{e}^{TD , min} + {R}_{j , t}^{P} + {R}_{j , t}^{S} + {R}_{p , t}^{P} + {R}_{p , t}^{S} \leq {P}_{e , t}^{T D} \leq {P}_{e}^{TD , max}$$
wherein P_{i,t} and P_{w,t} denote the active power output of the thermal power unit i and active power output of the wind power unit w at the time t, respectively; tranl denotes a transmission network load at a node a; P_{tranl,t} denotes a predicted transmission network load at the time t;
$${P}_{e , t}^{T D}$$
denotes a transmission capacity of a tie-line between a transmission network and a distribution network at the time t, where e denotes a distribution network connected to the node a; Ω(:,a) denotes a set of sending-end nodes connected to the node a, and b is any node in Ω(:,a); f_{ab,t} and f_{ba,t} denote a transmission power of a line ab and a transmission powers of a line ba; B_{ab} denotes a susceptance of the line ab; θ_{a,t}, θ_{b,t}, θ_{r,t} denote phase angles of the node a, the node b, and a reference node at the time t;
$${F}_{flow , ab}^{max}$$
denotes an upper limit of the transmission power of the line ab; T_{on,i} and T_{off,i} respectively denote a minimum start-up time and a minimum shut-down time of the thermal power unit i; u_{i,t}, u_{i,t-1}, and u_{i,k} denote start-stop states of the thermal power unit i at the time t, a time t−1, and a time k, respectively, where a value of 1 indicates in operation and a value of 0 indicates shut-down;
$${P}_{i , t - 1} , {R}_{i , t - 1}^{P} , {R}_{i , t - 1}^{S}$$
denote an active power output, a primary frequency regulation reserve capacity, and a secondary frequency regulation reserve capacity of the thermal power unit i at the time t−1, respectively;
$${ramp}_{i}^{u} and {ramp}_{i}^{d}$$
denote an upward ramping rate and a downward ramping rate of the thermal power unit i, respectively;
$${P}_{i}^{max} and {P}_{i}^{min}$$
denote an upper output limit and a lower output limit of the thermal power unit i, respectively;
$${P}_{w , t}^{un} and {P}_{w , t}^{min}$$
denote an upper output limit and a lower output limit of the wind power unit w, respectively;
$${R}_{i}^{max}$$
denote a maximum frequency regulation reserve capacity of the thermal power unit i;
$${R}_{w , i}^{max}$$
denotes a maximum frequency regulation reserve capacity of the wind power unit w; P_{j,n,t} and P_{p,n,t} respectively denote active powers injected into a node n by the distributed generator unit j and the photovoltaic unit p at the time t; Q_{j,n,t} and Q_{p,n,t} respectively denote reactive powers injected into the node n by the distributed generator unit j and the photovoltaic unit p at the time t; P_{mn,t} and Q_{mn,t} respectively denote an active power and a reactive power injected from a node m to the node n at the time t; P_{nd,t} and Q_{nd,t} respectively denote an active power and a reactive power output from the node n to a node d; Φ₁(n,:) denotes a set of sending-end nodes for which the node n is a terminal node, and Φ₂(n,:) denotes a set of terminal nodes for which the node n is a sending-end node, where d denotes any terminal node for which the node n is the sending-end node; I_{mn,t} denotes a current flowing through a line mn at the time t; rₘₙ and xₘₙ respectively denote a resistance and a reactance of the line mn;
$${P}_{e , n , t}^{T D} and {Q}_{e , n , t}^{T D}$$
respectively denote an active power and a reactive power transmitted through a tie-line between the transmission network and the distribution network into the node n at the time t; P_{distl,n,t} and Q_{distl,n,t} denote a predicted active load and a predicted reactive load at the node n at the time t, respectively; U_{m,t} and U_{n,t} denote a voltage of the node m and a voltage of the node n at the time t, respectively;
$${U}_{n}^{max} and {U}_{n}^{min}$$
denote an upper voltage limit and a lower voltage limit of the node n, respectively;
$${P}_{j}^{max} and {P}_{j}^{min}$$
denote an upper output limit and a lower output limit of the distributed generator unit j, respectively; P_{p,t} denotes an active power output of the photovoltaic unit p;
$${P}_{p , t}^{un} and {P}_{p , t}^{min}$$
denote an upper output limit and a lower output limit of the photovoltaic unit p, respectively;
$${R}_{j}^{max}$$
denote a maximum frequency regulation reserve capacity of the distributed generator unit j;
$${R}_{p , t}^{max}$$
denote a maximum frequency regulation reserve capacity of the photovoltaic unit p;
$${P}_{e}^{TD , min} and {P}_{e}^{TD , max}$$
respectively denote a lower transmission capacity limit and an upper transmission capacity limit of the tie-line between the transmission network and the distribution network.

7. The method of claim 6, wherein the converting the two-stage robust unit commitment optimization model of the transmission and distribution network into a mixed-integer second-order cone programming model, and iteratively solving the mixed-integer second-order cone programming model includes:
decomposing the objective function of the two-stage robust unit commitment optimization model of the transmission and distribution network into a master problem and a subproblem, wherein a transformed objective function and transformed constraint conditions are expressed in a matrix form, and the master problem is expressed as:
$$\{ \begin{matrix}{min}_{x} {c}_{M P}^{T} x + η \\ s . t . Ax \leq d , η \geq {c}_{S P}^{T} {y}_{l} \\ B {y}_{l} + f = 0 \\ E {y}_{l} \leq g \\ F x + G {y}_{l} \leq z \\ H {y}_{l} + K {h}_{l} \leq p \\ {‖ {O}_{m} {y}_{l} ‖}_{2} \leq {q}_{m}^{T} {y}_{l}\end{matrix} ;$$
wherein x denotes a decision variable;
$${c}_{M P}^{T}$$
denotes a coefficient vector related to the variable x in the objective function;
$${c}_{M P}^{T}$$
denotes a transpose of a cost coefficient matrix of the master problem; η denotes a relaxation variable of the subproblem;
$${c}_{S P}^{T}$$
denotes a transpose of a cost coefficient matrix of the subproblem; yₗ denotes a solution of the subproblem after an l-th iteration; hₗ denotes a worst-case scenario of the wind power output and the photovoltaic power output after the l-th iteration; Oₘ denotes a variable coefficient matrix corresponding to a branch m with the node n as a terminal node in a second-order cone constraint; qₘ^{T} denotes a transpose of a constraint constant matrix corresponding to the branch branch m with the node n as the terminal node in the second-order cone constraint; A, B, E, F, G, H, K, and O denote corresponding variable coefficient matrices; and d, f, g, z, p, and q denote corresponding constraint constant matrices;
the subproblem is expressed as:
$$\{ \begin{matrix}{max}_{h ∈ U} {min}_{y ∈ ψ ( x , h )} {c}_{S P}^{T} y \\ s . t . By + f = 0 ( λ ) \\ E y \leq g ( γ ) \\ F {x}_{l}^{*} + G y \leq z ( μ ) \\ H y + K h \leq p ( ζ ) \\ {‖ {O}_{m} y ‖}_{2} \leq {q}_{m}^{T} y ( {π}_{1} , {π}_{2} )\end{matrix} ;$$
wherein y denotes a set of second-stage optimization variables; U denotes the set including the uncertainty set of wind power output and the uncertainty set of photovoltaic power output; h denotes a set of uncertain wind power output and photovoltaic power output; ψ(x, h) denotes a feasible region of y after determining x and h;
$${x}_{l}^{*}$$
denotes a solution of the master problem after the l-th iteration; and λ, γ, μ, ζ, π₁, and π₂ denotes dual variables corresponding to constraints of the subproblem;
since a max-min bilevel model in the subproblem cannot be directly solved by a solver, an inner-layer minimization problem is converted into a dual maximization problem by using the strong duality theory and a big-M technique, and the dual maximization problem is combined with an outer layer to obtain a single-layer maximization model as follows:
$$\{ \begin{matrix}{max}_{h ∈ U , λ , γ , μ , ζ , {π}_{1} , {π}_{2}} ( {f}^{T} λ - {g}^{{T}_{Y}} - {( F {x}_{i}^{*} - z )}^{T} μ - {( K \cdot {p}^{p r e} )}^{T} ζ + \\ {( K \cdot Δ P )}^{T} \cdot {A}^{-} + {p}^{T} ζ ) \\ s . t . {c}_{S P} + {B}^{T} λ + {E}_{γ}^{T} + {G}^{T} μ + {H}^{T} ζ + {\sum }_{m} ( {O}_{m}^{T} {π}_{1 , m} - {q}_{m}^{T} {π}_{2 , m} ) = 0 \\ {‖ {π}_{1 , m} ‖}_{2} \leq {π}_{2 , m} \\ γ \geq 0 , μ \geq 0 , ζ \geq 0 , {π}_{2} \geq 0 \\ - {M}_{2} {α}^{-} \leq {A}^{-} \leq {M}_{2} {α}^{-} \\ - {M}_{2} ( 1 - {α}^{-} ) \leq {A}^{-} - ζ \leq {M}_{2} ( 1 - {α}^{-} ) \\ {α}^{-} \leq 1 \\ {α}^{-} ∈ \{ 0 , 1 \}\end{matrix} ;$$
wherein P^{pre} denotes a set of predicted wind power output and predicted photovoltaic power output; ΔP denotes a set of maximum allowable fluctuation deviations of wind power output and photovoltaic power output; π_{1,m} and π_{2,m} denote a dual variable corresponding to a left-hand side and a dual variable corresponding to a right-hand side of the second-order cone constraint, respectively; α⁻ denote a set of binary variables indicating whether wind power output and photovoltaic power output at the time t reach interval boundaries; M₂ denotes an artificial variable introduced by the big-M technique; and A⁻ denotes an introduced continuous auxiliary variable.
